(19) United States
(12) Patent Application Publication
(10) Pub. No.: US 2012/0167047 A1
(43) Pub. Date: Jun. 28, 2012

(54) SYSTEM AND METHOD FOR AUTOMATIC CREATION OF WEB CONTENT FOR MOBILE COMMUNICATORS

(75) Inventors: Eran Shmuel Wyler, Modi'in (IL); Gil Ilani, Tel Aviv (IL); Ron Elrom, Ra'anana (IL); Dror Nahmias, Sde Hemed (IL); Moti Zaltsman, Netanya (IL); Yosi Gabay, Herzilia (IL); Einat Kinamon, Tel Aviv (IL); Naaman Shefi, Zoran (IL); Oded Mashbach, Karkur (IL); Gal Briner, Hod Hasharon (IL); Nir Shney-Dor, Rishon Lezion (IL)

(73) Assignee: Infogin Ltd., Kfar Saba (IL)

(21) Appl. No.: 12/808,970

(22) PCT Filed: Dec. 17, 2008
(86) PCT No.: PCT/IL08/01634

§ 371 Date: Apr. 7, 2011

Related U.S. Application Data
(60) Provisional application No. 61/014,201, filed on Dec. 17, 2007.

(51) Int. Cl. G06F 9/44

(52) U.S. Cl. 717/122

(57) ABSTRACT

A method for creating applications optimized for use on multiple mobile devices, the method including using a computer to generate a single version of an application including at least one of content and functionality, providing the single version of the application via a computer network to a mobile device adaptation server and employing the mobile device adaptation server to automatically modify the single version of the application so as to create multiple versions corresponding to the single version, each of the multiple versions being optimized for at least one different mobile device platform.

### REFERENCE TO RELATED APPLICATIONS

Reference is made to U.S. Provisional Patent Application No. 61/014,201, entitled IMP DEVELOPMENT PLATFORM AND MOBILE MARKUP LANGUAGE EXTENSION, filed Dec. 17, 2007, the disclosure of which is hereby incorporated by reference and priority of which is hereby claimed pursuant to 37 CFR 1.78(a) (4) and (5)(i).

Reference is further made to Applicant's co-pending U.S. patent applications, the disclosures of which are hereby incorporated by reference:

U.S. Patent Application Publication No. 2008/0010335 entitled METHOD AND APPARATUS FOR ANALYZING, PROCESSING AND FORMATTING NETWORK INFORMATION SUCH AS WEB-PAGES, filed Jan. 23, 2006, which is a continuation of U.S. patent application Ser. No. 09/773,098, filed Jan. 31, 2001, now U.S. Pat. No. 7,047,033;

U.S. Patent Application Publication No. 2008/0016462 entitled METHODS AND APPARATUS FOR ENABLING USE OF WEB CONTENT ON VARIOUS TYPES OF DEVICES, filed Mar. 1, 2007;

U.S. Patent Application Publication No. 2008/0153467 entitled METHODS AND APPARATUS FOR ENABLING USE OF WEB CONTENT ON VARIOUS TYPES OF DEVICES, filed Mar. 1, 2007;

U.S. Patent Application Publication No. 2007/0206221 entitled METHODS AND APPARATUS FOR ENABLING USE OF WEB CONTENT ON VARIOUS TYPES OF DEVICES, filed Mar. 1, 2007;

U.S. patent application Ser. No. 11/713,588 entitled METHODS AND APPARATUS FOR ENABLING USE OF WEB CONTENT ON VARIOUS TYPES OF DEVICES, filed Mar. 1, 2007;

U.S. patent application Ser. No. 11/713,583 entitled METHODS AND APPARATUS FOR ENABLING USE OF WEB CONTENT ON VARIOUS TYPES OF DEVICES, filed Mar. 1, 2007;

U.S. patent application Ser. No. 11/713,584 entitled METHODS AND APPARATUS FOR ENABLING USE OF WEB CONTENT ON VARIOUS TYPES OF DEVICES, filed Mar. 1, 2007;

U.S. patent application Ser. No. 11/713,589 entitled METHODS AND APPARATUS FOR ENABLING USE OF WEB CONTENT ON VARIOUS TYPES OF DEVICES, filed Mar. 1, 2007; and

U.S. patent application Ser. No. 11/980,140 entitled METHOD AND APPARATUS FOR ANALYZING, PROCESSING AND FORMATTING NETWORK INFORMATION SUCH AS WEB-PAGES, filed Oct. 30, 2007, which is a continuation of U.S. patent application Ser. No. 09/773,098, filed Jan. 31, 2001, now U.S. Pat. No. 7,047,033.

### FIELD OF THE INVENTION

The present invention relates to methods and systems for creating content suitable for presentation on mobile communicators.

### BACKGROUND OF THE INVENTION

The following U.S. Patent documents are believed to represent the current state of the art:

U.S. Pat. Nos. 5,860,073; 5,909,568; 6,023,714; 6,157,935; 6,199,082; 7,047,033; 7,050,603; 7,116,765 and 7,228,340; and

U.S. Patent Application Publication No. 2005/0122997.

### SUMMARY OF THE INVENTION

The present invention seeks to provide methods and systems for creating content suitable for presentation and optimized functionality on mobile communicators, and specifically to provide methods and systems for automatically adapting content to be suitable for presentation and optimized functionality on many different types of mobile communicators.

There is thus provided in accordance with a preferred embodiment of the present invention a method for creating applications optimized for use on multiple mobile devices, the method including using a computer to generate a single version of an application including at least one of content and functionality, providing the single version of the application via a computer network to a mobile device adaptation server and employing the mobile device adaptation server to automatically modify the single version of the application so as to create multiple versions corresponding to the single version, each of the multiple versions being optimized for at least one different mobile device platform.

There is also provided in accordance with another preferred embodiment of the present invention a method for creating applications optimized for use on multiple mobile devices, the method including using a computer to generate a single version of an application including at least one of content and functionality, providing the single version of the application via a computer network to a mobile device adaptation server and employing the mobile device adaptation server to automatically modify the single version of the application so as to create multiple versions corresponding to the single version, each of the multiple versions being optimized for at least one different community of users identified by a characteristic of a request for the application.

There is further provided in accordance with yet another preferred embodiment of the present invention a method for creating applications optimized for use on multiple mobile devices, the method including using a computer to generate a single version of an application including at least one of content and functionality, providing the single version of the application via a computer network to a mobile device adaptation server and employing the mobile device adaptation server to automatically modify the single version of the application so as to create multiple versions corresponding to the single version, each of the multiple versions being optimized for at least one different mobile device platform being used by at least one different community of users identified by a characteristic of a request for the application.

Preferably, the single version is suitable for presentation on a device. Additionally, the single version is suitable for presentation on a mobile device.

Alternatively, the single version is not suitable for presentation on a device. Alternatively, the single version is not suitable for presentation on a mobile device.

In accordance with a preferred embodiment of the present invention, the employing the mobile device adaptation server includes automatically creating the multiple versions each having user interface features matched to the user interfaces of at least one different mobile device platform. Additionally or alternatively, the employing the mobile device adaptation server includes automatically creating the multiple versions each having functional features matched to the functional capabilities of at least one different mobile device platform.

Preferably, the employing the mobile device adaptation server to automatically modify the single version to create multiple versions takes place in real time in response to a request.

In accordance with a preferred embodiment of the present invention the using a computer to generate a single version includes defining one or more sources. Additionally, the using a computer to generate a single version also includes manipulating the one or more sources. Additionally or alternatively, the one or more sources include at least one of a web page, an XML file, an RSS feed, a file type and an API type.

Preferably, the using a computer to generate a single version also includes defining structures and rules for retrieving data from the one or more sources and for manipulation of the data retrieved. Additionally or alternatively, the using a computer to generate a single version also includes defining a style, a layout and a look-and-feel for the application. Alternatively or additionally, the using a computer to generate a single version also includes defining a desired user interface and functionality.

In accordance with a preferred embodiment of the present invention the using a computer to generate a single version also includes using a plurality of components, functions and attributes to define attributes of a mobile communicator page. Additionally, the attributes of a mobile communicator page are defined using an application specific markup language.

Preferably, the method also includes previewing the single version. Additionally or alternatively, method also includes previewing at least one of the multiple versions.

There is still further provided in accordance with even a further embodiment of the present invention a system for creating applications optimized for use on multiple mobile devices, the system including a computer operative to generate a single version of an application including at least one of content and functionality and a mobile device adaptation server, connected to the computer via a computer network, operative to automatically modify the single version of the application so as to create multiple versions corresponding to the single version, each of the multiple versions being optimized for use on at least one different mobile device platform.

There is yet further provided in accordance with another embodiment of the present invention a system for creating applications optimized for use on multiple mobile devices, the system including a computer operative to generate a single version of an application including at least one of content and functionality and a mobile device adaptation server, connected to the computer via a computer network, operative to automatically modify the single version of the application so as to create multiple versions corresponding to the single version, each of the multiple versions being optimized for use on at least one mobile device of at least one different community of users identified by a characteristic of a request for the application.

There is also provided in accordance with yet another embodiment of the present invention a system for creating applications optimized for use on multiple mobile devices, the system including a computer operative to generate a single version of an application including at least one of content and functionality and a mobile device adaptation server, connected to the computer via a computer network, operative to automatically modify the single version of the application so as to create multiple versions corresponding to the single version, each of the multiple versions being optimized for use on at least one different mobile device of at least one different community of users identified by a characteristic of a request for the application.

Preferably, the single version is suitable for presentation on a device. Additionally, the single version is suitable for presentation on a mobile device.

Alternatively, the single version is not suitable for presentation on a device. Additionally, the single version is not suitable for presentation on a mobile device.

In accordance with a preferred embodiment of the present invention, the multiple versions each have user interface features matched to the user interfaces of at least one different mobile device platform. Additionally or alternatively, the multiple versions each have functional features matched to the functional capabilities of at least one different mobile device platform.

Preferably, the mobile device adaptation server is operative to create one of the multiple versions by automatically modifying the single version in real time in response to a request, the one of the multiple versions being optimized for a mobile device sending the request.

In accordance with a preferred embodiment of the present invention the single version includes one or more sources. Additionally, the computer is operative to generate the single version by manipulating the one or more sources. Additionally or alternatively, the one or more sources include at least one of a web page, an XML file, an RSS feed, a file type and an API type.

Preferably, the computer is operative to define structures and rules for retrieving data from the one or more sources and for manipulation of the data retrieved. Additionally or alternatively, the computer is operative to define a style, a layout and a look-and-feel for the application. Alternatively or additionally, the computer is operative to define a desired user interface and functionality.

In accordance with a preferred embodiment of the present invention the computer is operative to use a plurality of components, functions and attributes to define attributes of a mobile communicator page. Additionally, the attributes of a mobile communicator page are defined using an application specific markup language.

Preferably, the system also includes a viewer operative to preview the single version. Additionally, the viewer is operative to preview at least one of the multiple versions.

In accordance with a preferred embodiment of the present invention the request includes information identifying the type of mobile communicator requesting the application. Preferably, the system also includes a mobile communicator characteristics database operative to store characteristics of the mobile device.

Preferably, the request includes information identifying a community to which a user of the mobile communicator making the request belongs. In accordance with a preferred embodiment of the present invention the system also includes a community requirements database operative to store characteristics of the at least one different community of users.

### BRIEF DESCRIPTION OF THE DRAWINGS

The present invention will be understood and appreciated more fully from the following detailed description, taken in conjunction with the drawings in which:

FIG. 1 is a simplified illustrative drawing showing generation of content and adaptation of the content suitable for display on many different types of mobile communicators, in accordance with a preferred embodiment of the present invention;

FIG. 2 is a simplified illustrative drawing showing generation of content and adaptation of the content into content suitable for display on many different types of mobile communicators, in accordance with another preferred embodiment of the present invention;

FIG. 3 is a simplified flowchart illustrating creation of content suitable for adaptation in accordance with a preferred embodiment of the present invention; and

FIGS. 4A and 4B together are a simplified flowchart illustrating adaptation of content in accordance with an embodiment of the present invention.

### DETAILED DESCRIPTION OF PREFERRED EMBODIMENTS

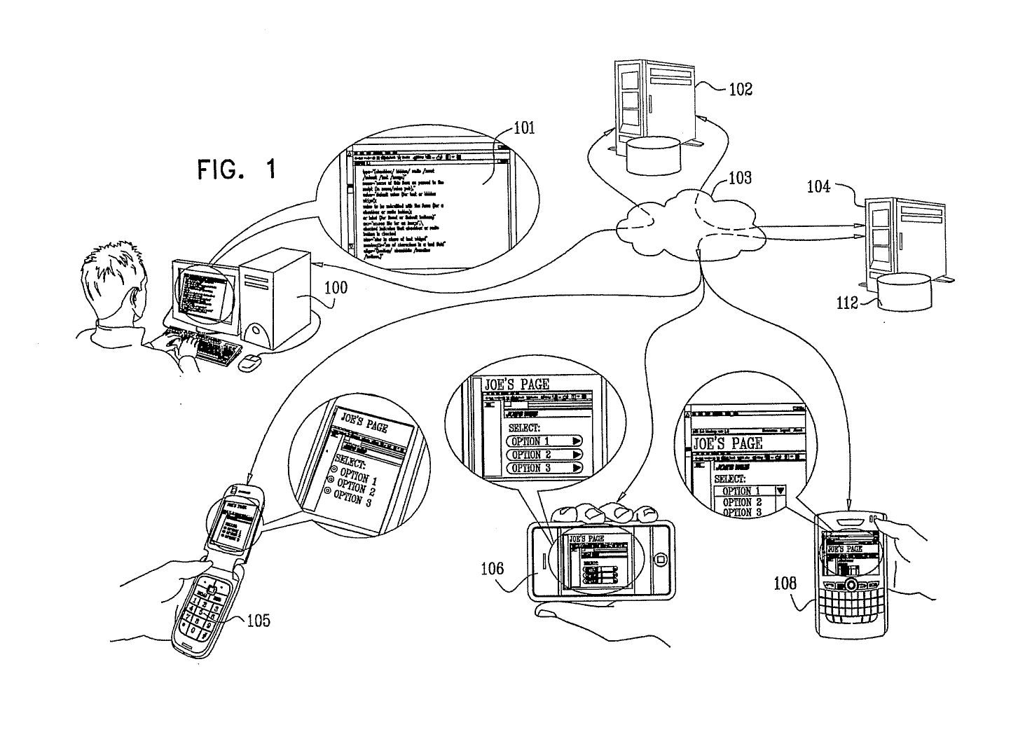

Reference is now made to FIG. 1, which is a simplified illustrative drawing showing generation of content and adaptation of the content suitable for display on many different types of mobile communicators, in accordance with a preferred embodiment of the present invention.

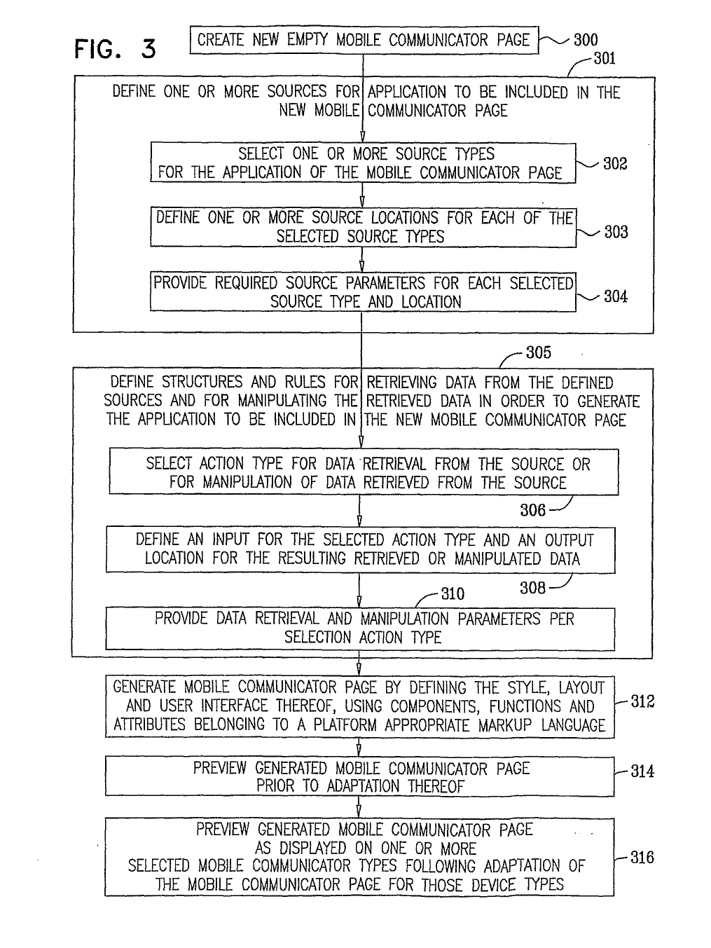

As seen in FIG. 1 a user, such as a computer programmer, employs a computer 100 to generate a single version of an application 101, including content and functionality, using tools constructed and operative in accordance with a preferred embodiment of the present invention, as described in further detail hereinbelow with reference to FIG. 3. The application 101 is preferably supplied to an application server 102 via a computer network 103, such as the Internet, and may be made accessible to users via the Internet. Preferably, the application 101 is optimized for use on one type of mobile communicator (not shown).

In accordance with a preferred embodiment of the present invention, and as described in further detail hereinbelow, the single version of application 101 is communicated from the application server 102 to a mobile device adaptation server 104 in response to a request from the mobile device adaptation server 104 and the mobile device adaptation server 104 then automatically modifies the single version of application 101 so as to create multiple versions corresponding to the single version, each of the multiple versions being optimized for at least one different mobile device type, such as a mobile device platform.

As seen, three users employ different types of mobile communicators 105, 106 and 108, to request the application 101 from mobile device adaptation server 104, via the Internet. Preferably, information identifying the type of mobile communicator requesting the application 101 is included in the request.

In accordance with a preferred embodiment of the present invention, upon receipt of the requests for application 101, the mobile device adaptation server 104 downloads the application 101 from the application server 102. The adaptation server 104 then retrieves from each request, information identifying the type of mobile communicator from which the request was transmitted, accesses a mobile communicator characteristics database 112 associated therewith to determine characteristics, including structural and functional parameters, of the mobile communicator, and automatically adapts the application 101 for optimal use on that type of mobile communicator.

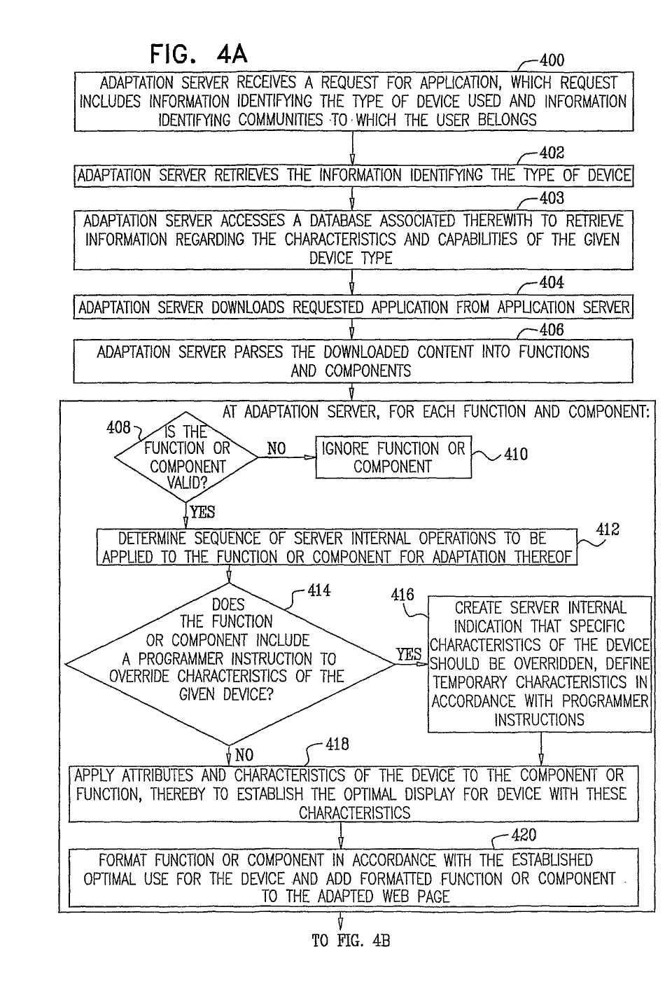

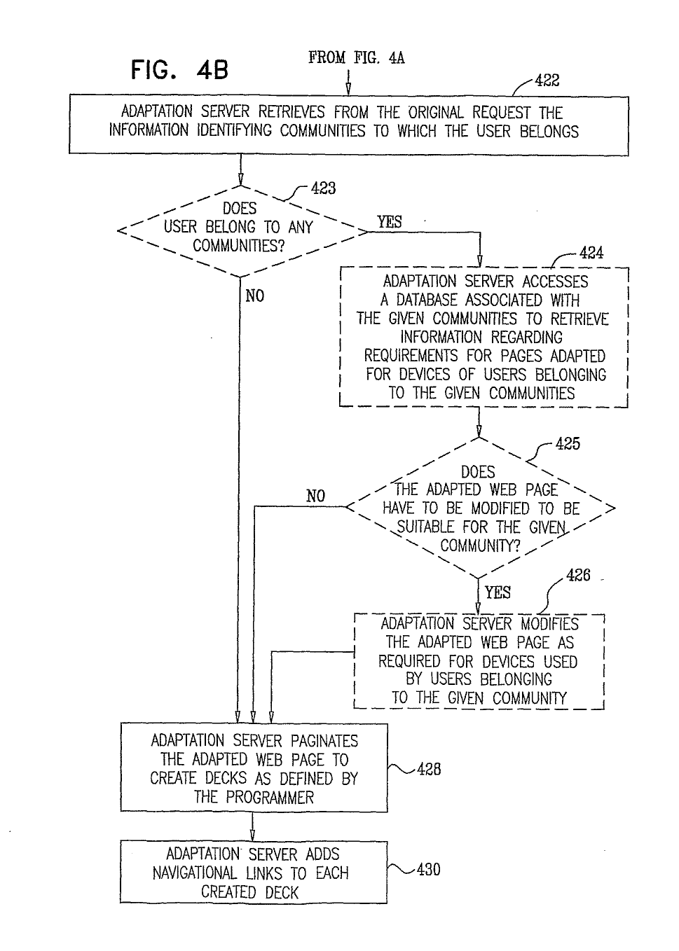

As described hereinbelow with reference to FIGS. 4A and 4B, the application 101 is adapted by adaptation server 104 for optimized use on each type of mobile communicator, including mobile communicators 105, 106 and 108, based on the specific properties and capabilities of each of these mobile communicators, notwithstanding the fact that the mobile communicators may share similar characteristics.

As seen in FIG. 1, the content of application 101 is displayed on mobile communicator 105 as a web page, including a top bar and a sidebar, and having the title “Joe's Page”. On mobile communicator 106, the same content is displayed as a web page including a top bar and a side bar, and having the title “Joe's Page”, and on mobile communicator 108, the content is displayed as a web page having a top title, a secondary title “Joe's Page”, and a sidebar.

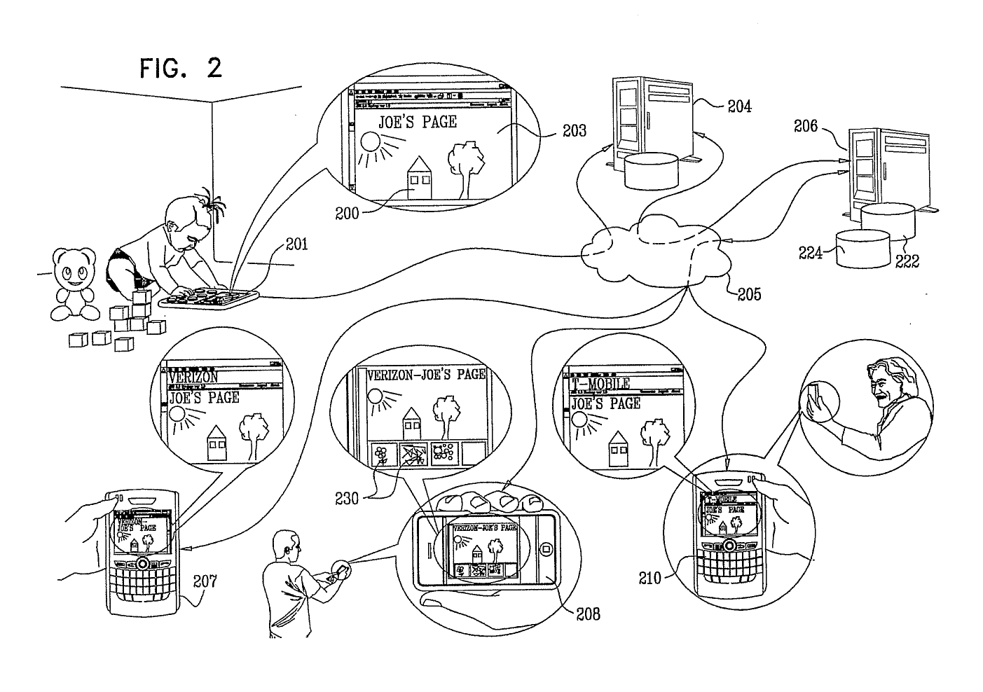

Reference is now made to FIG. 2, which is a simplified illustrative drawing showing generation of an application, including content and functionality, and adaptation of the content and functionality into content and functionality optimized for use on many different types of mobile communicators, in accordance with another preferred embodiment of the present invention.

As seen in FIG. 2, a young child draws a picture 200 on a children's computer 201, using a drawing tool. The child or a caregiver may then turn the drawing into a web page 203, such as by a caregiver pressing a “publish” button (not shown) on the children's computer 201. Preferably, the “publish” button activates a software tool which uses the drawing 200 to generate a single version of an application including content and functionality, using tools constructed in accordance with a preferred embodiment of the present invention, as described in further detail hereinbelow with reference to FIG. 3. The content and functionality is then made accessible to users, such as the child's family members, via the Internet.

In accordance with a preferred embodiment of the present invention, and as described in further detail hereinbelow, the single version of the application is preferably supplied to an application server 204 via a computer network 205, such as the Internet, and may be made accessible to users via the Internet. Preferably, the application is optimized for use on one type of mobile communicator (not shown).

In accordance with a preferred embodiment of the present invention, and as described in further detail hereinbelow, the single version of the application is communicated from the application server 204 to a mobile device adaptation server 206 in response to a request from adaptation server 206 and the adaptation server 206 then automatically modifies the single version of the application so as to create multiple versions corresponding to the single version, each of the multiple versions being suitable for at least one different mobile device and/or for at least one community of users, such as users receiving service from a specific service provider.

As seen, three users employ mobile communicators 207, 208 and 210, to request the application from adaptation server 206 via the Internet. Mobile communicators 207 and 210 are of the same type, and mobile communicator 208 is of a different type. Preferably, information identifying the type of mobile communicator requesting the content and information identifying the service provider through which the request is transmitted is included in the request.

In accordance with a preferred embodiment of the present invention, upon receipt of the requests for the application, the adaptation server 206 downloads the application from the application server 204. The adaptation server 206 then retrieves from each request, information identifying the type of mobile communicator from which the request was transmitted and information identifying the service provider through which the request was transmitted, accesses a mobile communicator characteristics database 222 associated therewith to determine characteristics of the mobile communicator and a community requirements database 224 associated therewith to determine requirements of the service provider, and automatically adapts the content for optimal presentation on that type of mobile communicator which is serviced by that service provider.

As described hereinbelow with reference to FIGS. 4A and 4B, the application is adapted for presentation on each type of mobile communicator, including mobile communicators 207, 208 and 210, based on the specific properties and capabilities of each of these mobile communicators notwithstanding the fact that the mobile communicators may share similar characteristics.

As seen in FIG. 2, mobile communicator 207 is serviced by a first service provider, such as Verizon Wireless, and therefore the web page 203 is displayed on mobile communicator 207 as a complete web page including the drawing created by the child, and the title “Verizon—Joe's Page” as well as menus and navigation tools. On mobile communicator 208, which is also serviced by the first service provider, Verizon Wireless, the same web page 203 is displayed as a web page including the drawing, the title “Verizon—Joe's page”, and a plurality of thumbnails 230 allowing access to other children's drawings. On mobile communicator 210, which is of the same type as mobile communicator 207, but which is serviced by a second service provider, such as T-Mobile, the web page 203 is displayed as a complete web page including the drawing created by the child, and the title “Joe's Page”, as well as menus, navigation tools, and a page header “T-Mobile”.

Reference is now made to FIG. 3, which is a simplified flowchart illustrating creation of an application suitable for adaptation in accordance with a preferred embodiment of the present invention.

As seen in FIG. 3, an operator creating an application suitable for adaptation initially creates a new empty mobile communicator page, as seen at step 300. Subsequently the operator defines the sources for the data to be included in the mobile communicator page, manipulates these sources in order to obtain the desired application for the new mobile communicator page, and employs various components and functions in order to define the layout and look-and-feel of the application on the new mobile communicator page, as described in further detail hereinbelow.

As seen at step 301, the operator defines one or more sources for the application to be included in the new mobile communicator page, by selecting one or more source types as seen at step 302, defining one or more source locations for each selected source type as seen at step 303, and providing suitable parameters as seen at step 304.

The source type may be a web page, an XML file, an RSS feed, a file type or an API type. Preferably, when defining the locations of different sources, the operator provides the URLs for the locations, as well as parameters required for accessing the location, such as a server IP address, a port, a file folder name, specific API parameters and database table structure. The parameters provided in step 304 are used for defining the type of data and the method used for retrieving the data, for example, the type of data being html data which is retrieved by a ‘get http’ method, and may also include the URL from which the data should be obtained, parameter values which should be concatenated to the URL when sending the Get HTTP request, a wait period indicating when the data should be retrieved and other parameters required for enabling retrieval of the source.

Subsequently, the operator defines structures and rules for retrieving data from the defined sources and for manipulation of the retrieved data, in order to obtain the application to be included in the new mobile communicator page, as seen at step 305. This is done by selecting an action type as seen at step 306, defining an input for the data and output location for the data following manipulation by the selected action type as seen at step 308, and providing required data retrieval parameters for each selected action type as seen at step 310.

The action type may be ‘Select’, ‘Copy’, ‘Replace’, ‘Append Data’ or any other suitable action. The data retrieval parameters provided in step 310 are used for defining an input from which data should be taken for the action, a location to which the data should be output following the action, an indication whether the manipulated data should be saved and similar such parameters required for accurately manipulating the data by the selected action.

As seen at step 312, the operator then generates the mobile communicator page which is suitable for adaptation, by defining the style, layout and look-and-feel of the web page, as well as by defining a desired user interface and functionality. The operator defines these attributes of the mobile communicator page using a plurality of components, functions and attributes which are included in an application specific markup language, which is suitable for adaptation. The operator may use a Graphic User Interface tool, such as a “drag and drop” toolbar in order to place the functions and tags on the mobile communicator page being generated, or may alternately write the mobile communicator page directly using the application specific markup language tags and functions. The components, functions and attributes which may be used by the operator are listed in Tables 1, 2 and 3 of this application, which are described in further detail hereinbelow. It is appreciated that use of the functions and components of the application specific markup language allows the operator to generate a generic mobile communicator page, which can be adapted for viewing on multiple types of mobile communicators.

Following generation of a single version of the application which is suitable for adaptation, the operator may preview the generated web page. Preferably, the operator initially previews the generated page on a computer, prior to any adaptation thereof, as seen at step 314, and then previews the generated page as it would be presented on a number of selected mobile communicators of different types, following adaptation of the application for those mobile communicator types, as seen at step 316. The operator may preview the adapted content on a computer, on the mobile communicators, or on any other type of device which can simulate the mobile communicators.

As an example, an operator creating an application suitable for adaptation for CNN.com, would define the desired sources of information, such as the CNN main page located at http://www.cnn.com which is of web page type, an RSS feed of top stories such as that located at http://rss.cnn.com/rss/edition.rss, an RSS feed of world news such as that located at http://rss.cnn.com/rss/edition_world.rss and an RSS feed of videos such as that located at http://rss.cnn.com/rss/cnn_freevideo.rss, all of which are of RSS feed source type, and provides appropriate parameters for each of these selected sources.

Subsequently, the operator defines the data which should be retrieved out of these sources, by selecting a plurality of actions. For example, the operator may define that the main article and accompanying image should be selected from the CNN main page, and that the first five articles should be taken from each of the RSS feeds which are used as sources, each article including a title, a URL, text and an image if one exists. The operator then uses the functions and components included in the application specific markup language, which is suitable for adaptation, in order to create a desired User Interface and functionality.

In the current example, the operator may use a ‘table’ component to implement the CNN main article within the table, by defining a table including one row and two columns, such that the left cell of the table will include the image accompanying the article, which may be defined using the ‘Image’ component, and the right cell will contain the text, which may be defined using the ‘Text’ component.

The operator can then add the RSS feed elements by using the ‘Text’ component to generate new titles for each of the RSS feeds, using an ‘Anchor’ component in order to configure the URL of each RSS feed, using the ‘Video’ component in order to define video elements within the page.

The operator may additionally define how the application being created should be broken up into pages in the event that the screen of a device is not big enough to show the entirety of the application by using the ‘Pagination’ component, and can define a header and footer for the application using the IgHeader and IgFooter.

Additional details of the components, functions and attributes which may be used by the operator are provided in Tables 1, 2 and 3 which are described in further detail hereinbelow.

As explained hereinabove, the operator may preview the generated application both before and after adaptation for specific devices.

Reference is now made to Table 1, which provides listings of components which may be used by an operator creating a web page which is suitable for adaptation.

For each component, Table 1 provides a brief description of the functionality of the component and of parameters which are required in order to use the component.

It is appreciated that for each component listed in Table 1, the following parameters are always required:

An object ID which will be used to located the object in the generated web page;

A styling class—a CSS file which should be used for styling the object;

A style object—a specific style object which should be used for styling the object, if it is desired that the styling of the object be different from that defined in the styling class for this specific object; and

A report log parameter which is used by adaptation server.

TABLE 1

| Component | | |
|---|---|---|
| name | Functionality | Required parameters |
| Text | Generates a ‘span’ html tag - a | 1. Text to be displayed |
| | basic text object | |
| Anchor | Generates an ‘a’ html tag - a | 1. Text to be displayed, which is |
| | link object | clicked to reach the link |
| | | 2. Location to be linked to, ‘href’ |
| | | attribute of the ‘a’ tag |
| | | 3. List of objects to be included within |
| | | the generated tag |
| Image | Generates an ‘img’ html tag | 1. Source - the source of the image |
| | | 2. Image Type - regular or background |
| | | 3. Is Zoomable - determines whether to |
| | | implement a zoom functionality on the |
| | | image |
| Table₋ Cell | Generates a ‘td’ html tag - a | 1. Text to be displayed in the table cell |
| | table cell | 2. List of objects to be included within |
| | | the generated tag |
| Table₋ Row | Generates a ‘tr’ html tag - a | 1. List of table cells to be included in |
| | table row | the table row |
| | | 2. List of objects to be included within |
| | | the generated tag |
| Table | Generates a ‘table’ html tag | 1. List of table rows to be included in |
| | | the table |
| | | 2. Degradation type for devices that do |
| | | not support display of a table |
| | | 3. List of objects to be included within |
| | | the generated tag, such as a Table title |
| Style class | Creates user defined classes for | |
| | styling | |
| Static image | Creates an image that may | 1. Source for the images library |
| | have different sizes based on | |
| | the device on which it is | |
| | displayed | |
| Radio button | Creates a radio button object | 1. List of values |
| | that will be adapted according | 2. Default value |
| | to device's capabilities and | |
| | conventions | |
| Check Box | Creates a check box object that | 1. List of values |
| | will be adapted according to | 2. Default value |
| | device's capabilities and | |
| | conventions | |
| Combo Box | Creates a combo box object | 1. List of values |
| | that will be adapted according | |
| | to device's capabilities and | |
| | conventions | |
| Animated gif | Creates a section of the content | 1. List of images to be displayed in a |
| | which includes an image which | cyclic manner |
| | is replaced by another image | 2. Predetermined time duration for |
| | after a predetermined time | switching images |
| | duration elapses, such that | |
| | images are redisplayed in a | |
| | cyclic manner | |
| Frame | Creates a frame objects that | List of objects to be included in the |
| | wraps a section of the page and | frame |
| | gives it visual separation. | |
| Horizontal | Creates a horizontal menu | 1. List of links to be included in the |
| menu | | menu |
| | | 2. Delimiter - the character separating |
| | | the links in the provided list |
| | | 3. IGRule - definition of a rule to be |
| | | used by the Horizontal Menu Rule |
| | | object described hereinbelow |
| Vertical menu | Creates a vertical menu | 1. List of links to be included in the |
| | | menu |
| | | 2. Delimiter - the character separating |
| | | the links in the provided list |
| | | 3. IGRule - definition of a rule to be |
| | | used by the Vertical Menu Rule object |
| | | described hereinbelow |
| Button Menu | Creates a menu with a button | 1. list of links to be included in the |
| | look and feel | menu |
| | | 2. Delimiter - the character separating |
| | | the links in the provided list |
| | | 3. IGRule - definition of a rule to be |
| | | used by the Button Menu Rule object |
| | | described hereinbelow |
| Tabbed Menu | Creates a menu in which the | 1. list of links to be included in the |
| | link to the current page is | menu |
| | highlighted or in different color | 2. IGRule - definition of a rule to be |
| | | used by the Tabbed Menu Rule object |
| | | described hereinbelow |
| Toolbar | Creates an icon menu - such as | 1. List of links to be included in the |
| | that used for basic optional | menu |
| | functionalities like help, and | 2. List of images or text to be |
| | navigation. | displayed for each link |
| DropDown | Creates a drop down menu | 1. List of links to be included in the |
| Menu | which menu is shown only | menu |
| | after pressing a button or link | 2. IGRule - definition of a rule to be |
| | | used by the Drop Down Menu Rule |
| | | object described hereinbelow |
| Form₋ Input | Generates an ‘input’ html tag | 1. Input type |
| | | 2. A name for the input field |
| | | 3. A value to be included in the input |
| | | field |
| Form | Generates a ‘form’ html tag | 1. List of input fields to be included in |
| | | the form |
| | | 2. Indication to where the information |
| | | obtained by the form should be |
| | | forwarded |
| | | 3. Method for forwarding the |
| | | information - can be ‘get’ or ‘post’ |
| | | 4. List of objects to be included within |
| | | the generated tag |
| List | Generates a list | 1. List type - such as whether the list |
| | | should be unordered, bulleted, |
| | | numbered |
| | | 2. List of objects to be included within |
| | | the generated list |
| Access Link | Creates an access link element | 1. Access link ID - the id which will |
| | that will appear in all the | be used to locate the access link |
| | pages. An access link element | 2. Access Link Image - an image file |
| | is an image link typically | to be used as the icon for the link |
| | forming part of a navigation | 3. Access Link Tooltip - a description |
| | toolbar which may be related | to be shown when the mouse is |
| | to other navigation links within | hovering over the access link, in |
| | the adapted page itself or to | devices which support this |
| | URLs external to the adapted | 4. Desired location of the access link - |
| | page | in the header or footer |
| | | 5. Link - the location to which the |
| | | access link should lead - selected from |
| | | a predefined group of possible access |
| | | links |
| Custom | Creates a customized access | 1. Access link ID - the id which will |
| Access Link | link element that will appear in | be used to locate the access link |
| | all the pages included in a | 2. Access Link Image - an image file |
| | specific group of pages as | to be used as the icon for the link |
| | defined by the programmer | 3. Access Link Tooltip - a description |
| | | to be shown when the mouse is |
| | | hovering over the access link, in |
| | | devices which support this |
| | | 4. Desired location of the access link - |
| | | in the header or footer |
| | | 5. Link - location to which the access |
| | | link should lead |
| Atom | Creates an object that contains | 1. list of objects to be wrapped |
| | other objects and wraps them | |
| | as one atomic object | |
| Pagination | Creates a pagination element | |
| | for navigating the web site | |
| | when displayed in multiple | |
| | decks on a mobile | |
| | communicator | |
| AD Banner | Creates a banner section for | 1. Link to the advertised item |
| | advertisement | 2. Image to be displayed for providing |
| | | the advertisement |
| Page header | Creates a structured page | 1. List of images to be included in the |
| | header which will appear on all | header |
| | pages having URLs defined by | 2. List of links to be included in the |
| | the operator. The Page Header | header |
| | is defined in separate file that | 3. List of text objects to be included in |
| | aggregates common | the header |
| | customization objects. These | |
| | objects can be referred to from | |
| | any URL designed by the | |
| | operator. | |
| Page footer | Creates a structured page | 1. List of images to be included in the |
| | footer which will appear on all | footer |
| | selected pages having URLs | 2. List of links to be included in the |
| | defined by the operator. The | footer |
| | Page Footer is defined in | 3. List of text objects to be included in |
| | separate file that aggregates | the footer |
| | common customization | 4. Location parameters for each item in |
| | objects. These objects can be | the page footer, including |
| | referred to from any URL | interdependencies or default values |
| | designed by the operator. | defined according to the order of each |
| | | of the lists above |
| Logo | Creates a graphic header - | 1. Image to be used as the logo |
| | Logo | |
| Video Object | Creates a video link in the page | 1. Link - location of a video object to |
| | | which the video link should lead |
| Audio Object | Creates an audio link in the | 1. Link - location of an audio object to- |
| | page | which the audio link should lead |
| GPS | Creates an object that connects | 1. Information to be retrieved |
| connector | to the GPS forming part of a | |
| | mobile communicator, if such | |
| | exists, in order to retrieve or | |
| | insert information | |
| Accelerometer | Creates an object that connects | 1. Information to be retrieved |
| | to the accelerometer forming | |
| | part of a mobile communicator, | |
| | if such exists, in order to | |
| | retrieve or insert information | |
| Camera | Creates an object that connects | 1. Information to be retrieved |
| | to the camera forming part of a | |
| | mobile communicator, if such | |
| | exists, in order to retrieve or | |
| | insert information | |
| Bluetooth | Creates an object that connects | 1. Information to be retrieved |
| | to the bluetooth element | |
| | forming part of a mobile | |
| | communicator, if such exists, | |
| | in order to retrieve information | |
| Article Teaser | Enables the creation of | 1. Image object to be included in the |
| | aggregated sections that | section |
| | contain an image, a short | 2. Title - A Text, anchor or image |
| | article teaser, the article title | object to be included in the section |
| | and a link to the article. | 3. Article teaser - text object to be |
| | | included in the section |
| | | 4. Anchor object providing a link to the |
| | | article |
| Anchors List | Generates a list of anchors | 1. List of anchors |
| | which is displayed in | 2. Indication of the desired list style, |
| | accordance with a design | such as a bulleted list and a numbered |
| | determined by the operator | list |
| Anchors Table | Generates a table of links | 1. Title for the table |
| | | 2. A table object which includes the |
| | | links to be included in the Anchors |
| | | table |
| Breadcrumbs | Creates an object that displays | |
| | options for navigation inside | |
| | the website | |
| Form | An aggregated set of objects | 1. Text object to be included in the |
| Template | that can generate dedicated | form |
| | forms for: login, search, drop | 2. Text type to be included in the form |
| | down lists and radio buttons | 3. Image to be included in the form |
| | | 4. Submit attribute type to be included |
| | | in the form |
| | | Some parameters may be irrelevant for |
| | | some types of forms |
| DropDown | Enables the definition of | 1. Devices - a specific device type or a |
| Menu Rule | specific dropdown menu | group of device types for which the |
| | behaviors per device type or | behavior is being defined |
| | group of device types | 2. Rule used for overriding device |
| | | properties as found in a database of |
| | | devices - selected from a list of |
| | | possible rules |
| Horizontal | Enables the definition of | 1. Devices - a specific device type or a |
| Menu Rule | specific horizontal bar menu | group of device types for which the |
| | behaviors per device type or | behavior is being defined |
| | group of device types | 2. Rule used for overriding device |
| | | properties as found in a database of |
| | | devices - selected from a list of |
| | | possible rules |
| Vertical Menu | Enables the definition of | 1. Devices - a specific device type or a |
| Rule | specific vertical bar menu | group of device types for which the |
| | behaviors per device type or | behavior is being defined |
| | group of device types | 2. Rule used for overriding device |
| | | properties as found in a database of |
| | | devices - selected from a list of |
| | | possible rules |
| Button Menu | Enables the definition of | 1. Devices - a specific device type or a |
| Rule | specific button bar menu | group of device types for which the |
| | behaviors per device type or | behavior is being defined |
| | group of device types | 2. Rule used for overriding device |
| | | properties as found in a database of |
| | | devices - selected from a list of |
| | | possible rules |
| Tabbed Menu | Enables the definition of | 1. Devices - a specific device type or a |
| Rule | specific tabbed menu behaviors | group of device types for which the |
| | per device type or group of | behavior is being defined |
| | device types | 2. Rule used for overriding device |
| | | properties as found in a database of |
| | | devices - selected from a list of |
| | | possible rules |
| IG Filter | Generates IGML tags which | 1. List of objects to be included within |
| Object | are used for wrapping objects. | the generated tags |
| Create Widget | Generates a widget application | 1. Devices - selects a specific family |
| Object | out of selected elements | of widgets or an indication that all |
| | | widgets should be used |
| | | 2. Selected data for the encapsulating |
| | | elements or an indication that all |
| | | elements should be used |
| | | 3. Output Location of the widget |
| | | application |

Hereinbelow are additional details relating to each of the components included in Table 1.

The text component generates an Html text element to be included in the adapted web page. Typically, this component generates a ‘span’ Html tag which includes text provided by a programmer in the text component.

For example, a programmer of a web page suitable for adaptation may write the following section:

Text (“This text will be included in a text element in the resulting adapted page”).

Following adaptation, the above component would result in the following text being included in the adapted web page:

<span>This text will be included in a text element in the resulting adapted page</span>.

During adaptation, the adaptation server may also adapt the text to the characteristics of the device, such as by making sure that the text is in a style supported by the device, and that the lines of the text do not exceed the width of the device screen.

The anchor component generates an Html hyperlink to be included in the adapted web page. Typically, this component generates a ‘a’ Html tag. In order to use this component, the programmer must provide the location to which the link should direct a user, typically in the tref attribute of a link and the text to be displayed in the link. If it is desired to include additional attributes with the link, or additional objects, such as an image within the link, the programmer provides a list of these as parameters of the anchor component.

For example, a programmer of a web page suitable for adaptation may write the following section:

Anchor(“www.mywebpage.com”, “this is a link to my web page”).

Following adaptation, the above component would result in the following text being included in the adapted web page:

<a href=“www.mywebpage.com”> This is a link to my web page. </a>

During adaptation, the adaptation server may also adapt the link to the characteristics of the device, such as by making sure that the link is in a style supported by the device, and that the text included in the link does not exceed the width of the device screen.

Any additional components or functions included in an anchor component, such as the image component in the example above, is processed by the adaptation server separately, in a modular manner.

The image component generates an Html image to be included in the adapted web page. Typically, this component generates a ‘img’ Html tag. In order to use this component, the programmer must provide the image which is to be displayed. The programmer may also provide additional attributes of the image, such as a text to be displayed if the image cannot be displayed as in the html ‘alt’ attribute, image dimensions and Boolean attributes such as igKeepSize and igBest which are described hereinbelow with reference to Table 3.

For example, a programmer of a web page suitable for adaptation may write the following section:

Image(“my_picture.jpg”, “this is a picture of me”, 100, 50).

Following adaptation, the above component would result in the following text being included in the adapted web page:

<img src=”my_picture.jpg” alt=”this is a picture of me”
width=”100” height=”50”>

During adaptation, the adaptation server adapts the image to the characteristics of the device. For example, the adaptation server may change the dimensions of the image if the screen of the device is not large enough to display the original dimensions and/or if horizontal scrolling is not supported by the device. The adaptation server may also change the resolution of the image to be suited for the device. Additionally, since some devices only support some image formats, such as jpg, but do not support other image formats, such as tiff, the adaptation server may change the format of the image to be in a format supported by the requesting device. Furthermore, if the requesting device does not support the display of images, the adaptation server replaces the image with the text included in the ‘alt’ field of the image.

The table_cell component generates an Html table cell to be included in the adapted web page. Typically, this component generates a ‘td’ Html tag. In order to use this component, the programmer must provide the content to be included in the table cell. If it is desired to include additional attributes of the table cell, or additional objects, such as an image within the table cell, the programmer provides a list of these as parameters of the table_cell component. As explained hereinabove, an ID parameter is provided for each component. This attribute is crucial in elements such as table cells, because it enables a programmer to define a table row and a table including specific table cells.

For example, a programmer of a web page suitable for adaptation may write the following section:

Table_cell(“Snow White”, ID=“snow white”)

Table_cell(“Cinderella”, ID=“cinderella”).

Following adaptation, the above components would result in the following text being included in the adapted web page:

<td id=”snow white”>Snow White</td>
<td id=”cinderella”>Cinderella</td>

During adaptation, the adaptation server adapts the table cell to the characteristics of the device. For example, the adaptation server may change the dimensions of the table cell, if the screen of the device is not large enough to display the original dimensions. Additionally, the adaptation server may convert the table cell into plain text, for example to be included in a list, if a device cannot support tables.

The table_row component generates an Html table row to be included in the adapted web page. Typically, this component generates a ‘tr’ Html tag. In order to use this component, the programmer must provide a list of the table cells to be included in the table row. This may be done by defining the table cells within the table row, in which case the adaptation of the information is recursive, or by using the component ids of the desired table cells. If it is desired to include additional attributes of the table row, or additional objects, the programmer provides a list of these as parameters of the table_row component. As explained hereinabove, an ID parameter is provided for each component. This attribute is crucial in elements such as table rows, because it enables a programmer to define a table including specific table rows.

For example, a programmer of a web page suitable for adaptation may write the following section:

Table_row(“snow white”, “cinderella”, ID=“fairy tales”)

Table_row(table_cell(“cooking meat”, ID=“meat”), table_cell(“best desserts” ID=“desserts”), ID=“cooking”)

Following adaptation, the above component would result in the following text being included in the adapted web page:

<tr id=”fairy tales”>
<td id=”snow white”>Snow White</td>
<td id=”cinderella”>Cinderella</td>
</tr>
<tr id=”cooking”>
<td id=”meat”> Cooking meat</td>
<td id=”desserts>Best desserts</td>
</tr>

During adaptation, the adaptation server adapts the table row to the characteristics of the device. For example, the adaptation server may change the dimensions of the table row, if the screen of the device is not large enough to display the original dimensions. The adaptation server may also provide the table row as a list of text and not in the format of a table, if such a format is not supported by the device.

The table component generates an Html table to be included in the adapted web page. Typically, this component generates a ‘table’ Html tag. In order to use this component, the programmer must provide a list of the table rows to be included in the table. This may be done by defining the table rows within the table, in which case the adaptation of the information is recursive, or by using the component ids of the desired table rows. If it is desired to include additional attributes of the table, or additional objects, the programmer provides a list of these as parameters of the table component. The programmer preferably also provides a preferred degradation type which should be used by the adaptation server if a specific device does not support tables.

For example, a programmer of a web page suitable for adaptation may write the following section:

Table(“fairy tales”, “cooking”, degradation=rows)

Following adaptation, the above component would result in the following text being included in the adapted web page:

<table>
<tr id=”fairy tales”> ... </tr>
<tr id=”cooking”> ... </tr>
</table>

During adaptation, the adaptation server adapts the table to the characteristics of the device. In the above example, because the programmer defined the degradation type as an image, in a device that does not support the display of tables the above table would be broken down into rows and displayed as a collection of rows. Additionally, the table may be displayed as an image on devices supporting the display of images, and may be displayed as a list in devices that do not support images or tables. Additionally, the adaptation server may change the dimensions of the table, if the screen of the device is not large enough to display the original dimensions.

The style class component generates user defined styles for different classes of elements, such as images, anchors, text etc. In order to use this component, the programmer must provide a paired list of element types and required styles or style sheets defining the required styles.

During adaptation, the adaptation server uses the style class components for styling the adapted web page. However, if any of the styles defined in the style class component is not supported by a device, a different style is used. For example, the adaptation server may change colors and fonts of text to be different from those defined in a text style class, if the defined fonts or colors are not supported by the device currently requesting the content.

The static image component generates a set of images having different sizes, to be used on different devices according to the screen size. In order to use this component, the programmer must provide the source library of the image to be displayed. The programmer may also provide additional attributes of the images, such as a text to be displayed if the image cannot be displayed as in the html ‘alt’ attribute.

During adaptation, the adaptation server selects the optimal size for display on a given device based on the screen dimensions of the device. As a result of adaptation of this component, an Html ‘img’ tag is generated, in which the source is an image taken from the library of dedicated images. When adapting the content for a device that does not support the display of images, the adaptation server replaces the image with text describing the image, if such was provided by the programmer, or with an indication that an image is not being displayed in a given place in the page.

The animated gif component generates an image which is replaced by another image after a predetermined time duration elapses, and the images continue to change and be redisplayed in a cyclic manner. In order to use this component, the programmer must provide a list of images to be displayed, and a time duration to wait before switching images. The programmer may also provide additional attributes of the images, such as a text to be displayed if an image cannot be displayed as in the html ‘alt’ attribute.

During adaptation, the adaptation server generates a script which changes the image at the end of every predetermined time duration, for example, using JavaScript. When adapting the content for a device that does not support one scripting mechanism, the adaptation server adapts the scripting language being used. In the case of a device that does not support any scripting language, the images which should be displayed one after the other temporally, are displayed in sequence spatially, in a form of list of images which are all included on a single page at the same time. If a given device does not support the display of images, the adaptation server replaces the images with text describing the image, if such was provided by the programmer, or with an indication that an image is not being displayed in a given place in the page.

The Frame component generates a visual wrapping of a set of objects in order to display separation from the rest of the page sections. In order to use this component, the programmer must provide a list of objects to be included inside the frame. This may be done by defining the objects directly within the table, in which case the adaptation of the information is recursive, or by using the component ids of the desired elements.

During adaptation, the adaptation server will generate the frame according to the adaptation of the internal elements, and according to the device's screen size.

The horizontal menu component is used to generate a horizontal menu on the adapted web page. In order to use this component, the programmer must provide a list of links to be included in the menu, a definition of the delimiter used to separate the links in the list, such as a comma, a colon, a semicolon, a space or a pipe character (|). The programmer also defines an override rule for horizontal menus, which may be used by the horizontal menu rule component which is described in further detail hereinbelow.

During adaptation, the adaptation server generates a horizontal menu, for example, using a scripting language such as JavaScript, which enables the presentation of the horizontal menu with a web-like look-and-feel to it. In devices that do not support JavaScript or other scripting languages, the adaptation server may define the menu using tags of an adaptation server specific markup language, or tags of a known markup language such as HTML, XHTML or WAP. In devices which generally provide a specific presentation method, such as the iPhone, the adaptation server adapts the menu in accordance with the device presentation conventions. Additionally, the adaptation server adapts the menu in accordance with the size of the device screen. For example, if the device screen is not wide enough to display the full horizontal menu, the menu may be displayed as two horizontal menus one under the other, or as a vertical menu.

The vertical menu component is used to generate a vertical menu on the adapted web page. In order to use this component, the programmer must provide a list of links to be included in the menu, a definition of the delimiter used to separate the links in the list, such as a comma, a colon, a semicolon, a space or a pipe character (|). The programmer also defines an override rule for vertical menus, which may be used by the vertical menu rule component which is described in further detail hereinbelow.

During adaptation, the adaptation server generates a vertical menu, for example, using a scripting language such as JavaScript, which enables the presentation of the vertical menu with a web-like look-and-feel to it. In devices that do not support JavaScript or other scripting languages, the adaptation server may define the menu using tags of an adaptation server specific markup language, or tags of a known markup language such as HTML, XHTML or WAP. In devices which generally provide a specific presentation method, such as the iPhone, the adaptation server adapts the menu in accordance with the device presentation conventions. Additionally, the adaptation server adapts the menu in accordance with the size of the device screen, for example, by breaking the menu into several decks if necessary.

The button menu component is used to generate a button menu on the adapted web page. In order to use this component, the programmer must provide a list of links to be included in the menu, a definition of the delimiter used to separate the links in the list, such as a comma, a colon, a semicolon, a space or a pipe character (|). The programmer also defines an override rule for button menus, which may be used by the button menu rule component which is described in further detail hereinbelow.

During adaptation, the adaptation server generates a button menu, which is a menu having the look-and-feel of a group of buttons. This may be achieved, for example, using a scripting language such as JavaScript, which enables the presentation of the button menu with a web-like look-and-feel to it. In devices that do not support JavaScript or other scripting languages, the adaptation server may define the menu using tags of an adaptation server specific markup language, or tags of a known markup language such as HTML, XHTML or WAP. In devices which generally provide a specific presentation method, such as the iPhone, the adaptation server adapts the menu in accordance with the device presentation conventions. Additionally, the adaptation server adapts the menu in accordance with the size of the device screen. For example, the layout of the buttons in the menu can be changed from the style defined by a programmer in order to display the buttons on the device screen. Furthermore, if the device cannot support the display of buttons, the adaptation server adapts the menu to be displayed as a simple list of links.

The tabbed menu component is used to generate a menu which looks like a plurality of tabs, such that the tab of the page currently being viewed is highlighted or otherwise identified. In order to use this component, the programmer must provide a list of links to be included in the menu. The programmer also defines an override rule for tabbed menus, which may be used by the tabbed menu rule component which is described in further detail hereinbelow.

During adaptation, the adaptation server generates a tabbed menu, which is a menu having the look-and-feel of a group of tabs at the edges of pages, wherein the tab corresponding to the currently viewed page is highlighted or otherwise identified. This may be achieved, for example, by using a scripting language such as JavaScript, which enables the presentation of the tabbed menu with a web-like look-and-feel to it. In devices that do not support JavaScript or other scripting languages, the adaptation server may define the menu using tabs that include images as the tab headers. These images may be thumbnails of the page linked to by the tab, or images representative of the page linked to by the tab. In other devices, such as devices that do not support scripting languages and do not support the display of images, the adaptation server may define the tabbed menu using tags of an adaptation server specific markup language, or tags of a known markup language such as HTML, XHTML or WAP. In devices which generally provide a specific presentation method, such as the iPhone, the adaptation server adapts the menu in accordance with the device presentation conventions.

Additionally, the adaptation server adapts the menu in accordance with the size of the device screen. For example, if the device screen is not wide enough to display all the tabs in the menu in a single row, the tabbed menu may be displayed in two rows, one under the other. Furthermore, if the device cannot support the display of tabs, the adaptation server adapts the menu to be displayed as a simple list of links.

The toolbar component is used to generate an icon menu which is typically used for providing links to basic optional functionalities such as help and navigation. In order to use this component, the programmer must provide a list of links to be included in the toolbar, and a corresponding list including the text or image which should be displayed for each link in the toolbar.

During adaptation, the adaptation server generates a toolbar, including an icon menu which, in use, directs a user to the links provided by the programmer. Typically, the images or text provided by the programmer are displayed in the toolbar and are used by the user to indicate a specific page to which he would be directed when pressing a certain link in the toolbar. This may be achieved, for example, by using a scripting language such as JavaScript, which enables the presentation of the toolbar with a web-like look-and-feel to it. In devices that do not support JavaScript or other scripting languages, the adaptation server may define the toolbar tags of an adaptation server specific markup language, or tags of a known markup language such as HTML, XHTML or WAP. In devices that do not support the graphics required for displaying the menu of links as a toolbar, the links may be displayed in any other menu format, such as those described hereinabove. Additionally, in devices which do not support the display of images, the images used in the toolbar are replaced by text, such as the text provided by the programmer in the ‘alt’ attribute of the images.

In devices which generally provide a specific presentation method, such as the iPhone, the adaptation server adapts the menu in accordance with the device presentation conventions.

Additionally, the adaptation server adapts the menu in accordance with the size of the device screen. For example, if the device screen is not wide enough to display the whole toolbar in a single row, the toolbar may be displayed as two toolbars, one under the other.

The drop-down menu component is used to generate a drop down menu. In order to use this component, the programmer must provide a list of links to be included in the drop down menu. The programmer also defines an override rule for drop down menus, which may be used by the drop down menu rule component which is described in further detail hereinbelow.

During adaptation, the adaptation server generates a drop down menu. This may be achieved, for example, using a scripting language such as JavaScript, which enables the presentation of a drop down menu with a web-like look-and-feel to it. In devices that do not support JavaScript or other scripting languages, the adaptation server may define the menu using tags of an adaptation server specific markup language, or tags of a known markup language such as HTML, XHTML or WAP. In devices which generally provide a specific presentation method, such as the iPhone, the adaptation server adapts the menu in accordance with the device presentation conventions.

Additionally, if the device cannot support the display of a drop down menu, the adaptation server adapts the menu to be displayed as a simple list of links.

The form input component generates an Html form input element to be included in the adapted web page. Typically, this component generates a ‘input’ Html tag. In order to use this component, the programmer must provide the input type, such as text, checkbox and password, the input field name, and a default value for the input field, if such a value should be included, or a text to be displayed on the input element, for example, if it is a button. As explained hereinabove, an ID parameter is provided for each component. This attribute is crucial in elements such as form input, because it enables a programmer to define a form including specific form input fields.

For example, a programmer of a web page suitable for adaptation may write the following section:

Form_Input(“text”, “username”, “administrator”, ID=“username”)

Form_Input(“password”, “pwd”, ID=“pwd”).

Following adaptation, the above components would result in the following text being included in the adapted web page:

```
        <input type=”text” name=”username”
value=”administrator” id=”username”/>
        <input type=”password” name=”pwd” id=”pwd”/>
```

During adaptation, the adaptation server adapts the form input elements to the characteristics of the device. For example, the adaptation server may limit the size of a text input field or password input field to fit in the size of the device. This may be done automatically by the adaptation server, but may also be defined by the content programmer, using the IgFormat attribute described hereinbelow with reference to Table 3.

The form component generates an Html form to be included in the adapted web page. Typically, this component generates a ‘form’ Html tag. In order to use this component, the programmer must provide a list of the form input elements to be included in the form. This may be done by defining the table rows within the table, in which case the adaptation of the information is recursive, or by using the component ids of the desired form input elements. The programmer must also provide an action indication, which is an instruction of the location to which the filled out form should be forwarded, as well as a forwarding method, which is typically either ‘get’ or ‘post’. If it is desired to include additional attributes of the table, or additional objects, the programmer provides a list of these as parameters of the fowl component.

For example, a programmer of a web page suitable for adaptation may write the following section:

Form(Text(“username:”), “username”, Text(“password:”), “pwd”, “action.asp”, “get”)

Following adaptation, the above component would result in the following text being included in the adapted web page:

```
        <form action=”action.asp” method=”get”>
        <Span> username: </span> <input type=”text”
name=”username” value=”administrator” id=”username” />
        <Span>password:</span><input type=”password”
name=”pwd” id=”pwd”/>
        </form>
```

During adaptation, the adaptation server adapts the form to the characteristics of the device. For example, the adaptation server may limit the size of a text input field or password input field to fit in the size of the device. This may be done automatically by the adaptation server, but may also be defined by the content programmer, using the IgFormat attribute described hereinbelow with reference to Table 3.

The list component generates an Html list to be included in the adapted web page. Typically, this component generates a ‘ul’ Html tag or a ‘ol’ Html tag. In order to use this component, the programmer must provide the desired type of list, such as whether the generated list should be an ordered list, an unordered list, a bulleted list or a numbered list, as well as a list of elements to be included in the list being generated. This may be done by defining the elements within the list component, in which case the adaptation of the information is recursive, or by using the component ids of the desired list item elements.

For example, a programmer of a web page suitable for adaptation may write the following section:

List(Unordered, Text(“milk”), Text(“eggs”), Text(“apples”), ID=“groceries”)

Following adaptation, the above component would result in the following text being included in the adapted web page:

<ul id=”groceries>
<li>milk</li>
<li>eggs</li>
<li>apples</li>
</ul>

During adaptation, the adaptation server generates the required list and adapts it to the characteristics of the device. For example, the programmer may provide an instruction that the list be generated using a scripting language such as JavaScript, which enables the presentation of a list with a web-like look-and-feel to it. In devices that do not support JavaScript or other scripting languages, the adaptation server may define the list using tags of an adaptation server specific markup language, or tags of a known markup language such as HTML, XHTML or WAP, as shown in the example above. In devices which generally provide a specific presentation method, such as the iPhone, the adaptation server adapts the list in accordance with the device presentation conventions.

The access link component is used to generate an access link in the generated web page. An access link element is an image link typically forming part of a navigation toolbar, which image link may be related to other navigation links within the adapted page itself or to URLs external to the adapted page.

In order to use the access link component, the programmer must provide the access link ID, the location to which the access link should lead, the image to be used for the access link, a description to be shown when the mouse is hovering over the access link in devices which support this feature and an indication of the desired location of the access link, in the header or in the footer of the page. In a preferred embodiment of the present invention, the access link component can be selected from a predetermined list of access links, including, for example, ‘go to top of page’, ‘go to bottom of page’ and ‘find text’.

During adaptation, the adaptation server generates an access link displaying the image provided by the programmer, having the ID provided by the programmer and linking the location provided by the programmer. This may be achieved, for example, by defining the access link using tags of an adaptation server specific markup language, or tags of a known markup language such as HTML, XHTML or WAP. In devices that do not support the provision of text when the mouse hovers over a link, the adaptation server adds the explanatory text above the link in the adapted web page. Additionally, in devices which do not support the display of images, the image link is replaced by a textual link, such as one using the text provided by the programmer in the ‘alt’ attribute of the image.

The custom access link component is used to generate an access link in the generated web page and in all its derivative pages. A custom access link element is an image link typically forming part of a navigation toolbar, which image link may be related to other navigation links within the adapted page itself or to URLs external to the adapted page.

In order to use the custom access link component, the programmer must provide the access link ID, the location to which the access link should lead, the image to be used for the access link, a description to be shown when the mouse is hovering over the access link in devices which support this feature and an indication of the desired location of the access link, in the header or in the footer of the page.

During adaptation, the adaptation server generates an access link displaying the image provided by the programmer, having the ID provided by the programmer and linking the location provided by the programmer. This access link is added to the page, which may be achieved, for example, by defining the access link using tags of an adaptation server specific markup language, or tags of a known markup language such as HTML, XHTML or WAP. In devices that do not support the provision of text when the mouse hovers over a link, the adaptation server adds the explanatory text above the link in the adapted web page. Additionally, in devices which do not support the display of images, the image link is replaced by a textual link, such as one using the text provided by the programmer in the ‘alt’ attribute of the image.

The atom component instructs the adaptation server to group a list of components as a single component, to be displayed in a single deck. In order to use this component, the programmer must provide a list of components to be included in the new grouping component being generated. This may be done by defining the elements within the atom component, in which case the adaptation of the information is recursive, or by using the component ids of the components to be included in the group.

During adaptation, the adaptation server generally refers to the group of components as a single component, and displays them on a single deck, while taking into consideration the required or recommended deck size. For example, the adaptation server may end one deck and start another even if there is still room for additional components on the deck being ended, in order to create an empty deck which would enable the display of the entire group of components. In the event that the atom generated is larger than the maximal deck size of a specific device, the system will break the atom into its original elements.

The pagination component generates a pagination object, which enables navigation between multiple decks of the adapted web page. During adaptation, the adaptation server generates the pagination object, which may be achieved using a scripting language such as JavaScript, which enables the presentation of a pagination object with a web-like look-and-feel to it. In devices that do not support JavaScript or other scripting languages, the adaptation server may define the pagination object using tags of an adaptation server specific markup language, or tags of a known markup language such as HTML, XHTML or WAP.

In devices which generally provide a specific presentation method, such as the iPhone, the adaptation server adapts the pagination object in accordance with the device presentation conventions. The pagination object may also be displayed as a toolbar, in devices supporting this feature, in a similar manner to that described hereinabove with respect to the toolbar component. Additionally, in devices that don't enable use of any graphics, the pagination element may be displayed as a list of links.

The ad banner component generates in the adapted web page a banner section which is typically used for advertisement. In order to use this component, the programmer must provide a link to the advertised page and an image to be displayed in the advertisement banner.

During adaptation, the adaptation server generates the advertisement banner, which may be achieved using a scripting language such as JavaScript, which enables the presentation of an advertisement banner with a web-like look-and-feel to it. When generating the advertisement banner using a scripting language, the adaptation server preferably adds to the advertisement banner a show/hide functionality, which enables the user to click a link and hide the advertisement banner.

In devices that do not support JavaScript or other scripting languages, the adaptation server may define the advertisement using tags of an adaptation server specific markup language, or tags of a known markup language such as HTML, XHTML or WAP, such as by use of frames and images. In devices which generally provide a specific presentation method, such as the iPhone, the adaptation server adapts the advertisement banner in accordance with the device presentation conventions.

Additionally, when adapting the advertisement banner for devices having suitable capabilities, the adaptation server creates a frozen advertisement, which is constantly displayed and may be displayed on different parts of a page or deck depending on the location of the user's cursor. Furthermore, the adaptation server adapts the advertisement banner to be suitable for the screen dimensions of the given device, such as by resizing the advertisement image. If a given device does not support the display of images, the adaptation server replaces the advertisement image with text describing the image, if such was provided by the programmer.

The page header component instructs the adaptation server to generate a programmer defined page header for the adapted web page and all pages derived therefrom. In order to use this component, the programmer must provide lists of text components, image components and anchor components to be included in the header. This may be done by defining the elements within the page header component, in which case the adaptation of the information is recursive, or by using the component ids of the components to be included in the header. The programmer must also provide a list defining the absolute or relative location of each of the components included in the header.

The page header is typically defined in a separate file that aggregates common customization objects that can be referenced by multiple pages. Reference to the Page Header object is done via its ID.

During adaptation, the adaptation server generates the required header by placing components in their suitable locations, and adapts each of the components in accordance with the definitions for that component, as described hereinabove. The page header may be generated using a scripting language such as JavaScript, which enables the presentation of a page header with a web-like look-and-feel to it.

In devices that do not support JavaScript or other scripting languages, the adaptation server may define the page header using tags of an adaptation server specific markup language, or tags of a known markup language such as HTML, XHTML or WAP. In devices which generally provide a specific presentation method, such as the iPhone, the adaptation server adapts the page header in accordance with the device presentation conventions.

Furthermore, the adaptation server adapts the page header to be suitable for the screen dimensions of the given device, such as by resizing the header. If a given device does not support the display of images, the adaptation server replaces any images included in the header with text describing the image, if such was provided by the programmer, or with an indication that an image is not being displayed in a given place in the header.

The page footer component instructs the adaptation server to generate a programmer defined page footer for the adapted web page and all pages derived therefrom. In order to use this component, the programmer must provide lists of text components, image components and anchor components to be included in the footer. This may be done by defining the elements within the page footer component, in which case the adaptation of the information is recursive, or by using the component ids of the components to be included in the footer. The programmer must also provide a list defining the absolute or relative location of each of the components included in the footer.

The page footer is typically defined in a separate file that aggregates common customization objects that can be referenced by multiple pages. Reference to the Page Header object is done via its ID.

During adaptation, the adaptation server generates the required footer by placing components in their suitable locations, and adapts each of the components in accordance with the definitions for that component, as described hereinabove. The page footer may be generated using a scripting language such as JavaScript, which enables the presentation of a page footer with a web-like look-and-feel to it.

In devices that do not support JavaScript or other scripting languages, the adaptation server may define the page footer using tags of an adaptation server specific markup language, or tags of a known markup language such as HTML, XHTML or WAP. In devices which generally provide a specific presentation method, such as the iPhone, the adaptation server adapts the page footer in accordance with the device presentation conventions.

Furthermore, the adaptation server adapts the page footer to be suitable for the screen dimensions of the given device, such as by resizing the footer or images included therein. If a given device does not support the display of images, the adaptation server replaces any images included in the footer with text describing the image, if such was provided by the programmer, or with an indication that an image is not being displayed in a given place in the footer.

The logo component generates a graphic header for the page, which typically includes an image and is displayed in each deck of the adapted web page. Typically, this component generates a ‘img’ Html tag. In order to use this component, the programmer must provide the image which is to be displayed. The programmer may also provide additional attributes of the image, such as a text to be displayed if the image cannot be displayed as in the html ‘alt’ attribute, image dimensions and Boolean attributes such as igKeepSize and igBest which are described hereinbelow with reference to Table 3.

During adaptation, the adaptation server adapts the logo image to the characteristics of the device. For example, the adaptation server may change the dimensions of the image if the screen of the device is not large enough to display the original dimensions. The adaptation server may also change the resolution of the image to be suited for the device. Additionally, since some devices only support some image formats, such as jpg, but do not support other image formats, such as tiff, the adaptation server may change the format of the image to be in a format supported by the requesting device. Furthermore, if the requesting device does not support the display of images, the adaptation server replaces the image with the text included in the ‘alt’ field of the image.

The video object component generates a link to a video object to be included in the adapted web page. Typically, this component generates a ‘a’ Html tag. In order to use this component, the programmer must provide the location of the video to be displayed when pressing the link, typically in the ‘href’ attribute of a link, and the text to be displayed in the link.

For example, a programmer of a web page suitable for adaptation may write the following section:

Video_Object(“www.mypage.com/video.htm”, “click here to watch a video”).

Following adaptation, in devices which support videos, the above component would result in the following text being included in the adapted web page:

<a href=“www.mypage.com/video.htm”>click here to watch a video</a>

During adaptation, the adaptation server determines whether the device supports videos. If the device does support videos, the link is included in the adapted page. Otherwise, the link is not included, and the adaptation server may display a text indicating that there is supposed to be a video link in the given location, if such a text is provided by the programmer. The adaptation server also adapt the link to the characteristics of the device, such as by making sure that the link is in a style supported by the device, and that the text included in the link does not exceed the width of the device screen.

The audio object component generates a link to an audio object to be included in the adapted web page. Typically, this component generates a ‘a’ Html tag. In order to use this component, the programmer must provide the location of the audio element to be displayed when pressing the link, typically in the lire attribute of a link, and the text to be displayed in the link.

For example, a programmer of a web page suitable for adaptation may write the following section:

Audio_Object(“www.mypage.com/music.htm”, “click here to listen to music”).

Following adaptation, in devices which support videos, the above component would result in the following text being included in the adapted web page:

<a href=”www.mypage.com/music.htm ”>click here to
listen to music</a>

During adaptation, the adaptation server determines whether the device is capable of playing audio elements. If the device is capable of playing music, the link is included in the adapted page. Otherwise, the link is not included, and the adaptation server may display a text indicating that there is supposed to be an audio link in the given location, if such a text is provided by the programmer. The adaptation server also adapt the link to the characteristics of the device, such as by making sure that the link is in a style supported by the device, and that the text included in the link does not exceed the width of the device screen.

The GPS connector component generates an object that connects to the GPS forming part of a mobile communicator, if such exists, in order to retrieve information therefrom or insert information updates thereto. In order to use this component for retrieval of information, the programmer must provide an indication of the information that should be retrieved. In order to use this component for insertion of information, the programmer must provide the information to be inserted.

For example, a programmer may generate a web page suitable for adaptation, which illustrates the user's location and calculates the time of sunset based on the user's location. The programmer may use this component in order to retrieve the user's location from the GPS.

During adaptation, the adaptation server determines whether the device includes a GPS capability, and if so, whether this capability is activated. If the capability is active, the adaptation server adapts the web page in accordance with the programmer's instructions, such as by retrieving the user's location from the GPS and including it in the adapted web page. If the device does not include GPS capability, the adaptation server ignores this component and any instructions for retrieval of information from the GPS or insertion of information thereinto.

The accelerometer component generates an object that connects to the accelerometer forming part of a mobile communicator, if such exists, in order to retrieve information therefrom or insert information updates thereto. In order to use this component for retrieval of information, the programmer must provide an indication of the information that should be retrieved. In order to use this component for insertion of information, the programmer must provide the information to be inserted.

For example, a programmer may generate a web page suitable for adaptation, which illustrates the landscape where the user is currently located. The programmer may use this component in order to retrieve the incline of the landscape at the user's current location from the accelerometer.

During adaptation, the adaptation server determines whether the device includes an accelerometer, and if so, whether it is activated. If the accelerometer is active, the adaptation server adapts the web page in accordance with the programmer's instructions, such as by retrieving the incline at the user's location from the accelerometer and including it in the adapted web page. If the device does not include an accelerometer, the adaptation server ignores this component and any instructions for retrieval of information from the accelerometer or insertion of information thereinto.

The camera component generates an object that connects to the camera forming part of a mobile communicator, if such exists, in order to retrieve information therefrom or insert information updates thereto. In order to use this component for retrieval of information, the programmer must provide an indication of the information that should be retrieved. In order to use this component for insertion of information, the programmer must provide the information to be inserted.

For example, a programmer may generate a web page suitable for adaptation, which provides viewers an image of the landscape as seen by the user of the mobile communicator. The programmer may use this component in order to retrieve the image of the landscape as seen by the user from the camera.

During adaptation, the adaptation server determines whether the device includes a camera, and if so, whether it is active. If the camera is active, the adaptation server adapts the web page in accordance with the programmer's instructions, such as by retrieving from the camera an image of the landscape as seen by the user and including it in the adapted web page. If the device does not include a camera, the adaptation server ignores this component and any instructions for retrieval of information from the camera or insertion of information thereinto.

Additional exemplary uses for this component are in the creation of web pages using the camera of the mobile device as a webcam, or for using the camera's line of sight in order to carry out an action, such as scrolling.

The Bluetooth component generates an object that connects to the Bluetooth forming part of a mobile communicator, if such exists, in order to retrieve information therefrom. In order to use this component for retrieval of information, the programmer must provide an indication of the information that should be retrieved.

For example, a programmer may generate a web page suitable for adaptation, which includes a list of blue tooth connections to which the device may currently connect. The programmer may use this component in order to retrieve that list of devices from the blue tooth component of the mobile communicator.

During adaptation, the adaptation server determines whether the device includes a Bluetooth element, and if so, whether it is active. If the Bluetooth is active, the adaptation server adapts the web page in accordance with the programmer's instructions, such as by retrieving from the Bluetooth a list of devices to which the user may currently connect and including it in the adapted web page. If the device does not include a blue tooth element, the adaptation server ignores this component and any instructions for retrieval of information from the blue tooth.

The Article teaser component enables the generation of content based on a predetermined template, which is suitable for the presentation of an article including a title, an image, a link and a text object. In order to use this component, the programmer must provide the components to be placed in the template, i.e. the link, title, image and text object to be included in the article teaser generated according to the template. This may be done by defining the elements within the article teaser component, in which case the adaptation of the information is recursive, or by using the component ids of the components to be included in the article teaser.

During adaptation, the adaptation server formats the provided components in accordance with the article teaser template. It further adapts the formatted information, structured in the layout defined by the template, to be suitable for display on the given device. For example, the adaptation server may change the dimensions of the image if the screen of the device is not large enough to display the original dimensions and/or if horizontal scrolling is not supported by the device. The adaptation server may also change the resolution of the image to be suited for the device. Additionally, since some devices only support some image formats, such as jpg, but do not support other image formats, such as tiff, the adaptation server may change the format of the image to be in a format supported by the requesting device. Furthermore, if the requesting device does not support the display of images, the adaptation server replaces the image with the text included in the ‘alt’ field of the image.

The adaptation server may also adapt the included title, text and link to the characteristics of the device, such as by making sure that they are in a style supported by the device, and that they do not exceed the width of the device screen.

The anchor list component enables the generation of content based on a predetermined template, which is suitable for the presentation of a list of links. In order to use this component, the programmer must provide the links to be included in the template, as well as the desired style of the list, such as a numbered list, a bulleted list, an unordered list. The links may be defined within the anchor list component, in which case the adaptation of the information is recursive, or by using the component ids of the links to be included in the anchor list.

During adaptation, the adaptation server formats the provided links in accordance with the anchor list template and with the list style defined by the programmer. The anchor list may be generated using a scripting language such as JavaScript, which enables the presentation of a anchor list with a web-like look-and-feel to it. In devices that do not support JavaScript or other scripting languages, the adaptation server may define the anchor list using tags of an adaptation server specific markup language, or tags of a known markup language such as HTML, XHTML or WAP. In devices which generally provide a specific presentation method, such as the iPhone, the adaptation server adapts the anchor list in accordance with the device presentation conventions.

Additionally, the adaptation server adapts the formatted information, structured in the layout defined by the template, to be suitable for display on the given device. For example, the adaptation server may adapt the included links to the characteristics of the device, such as by making sure that they are in a style supported by the device, and that they do not exceed the width of the device screen.

The anchor table component enables the generation of content based on a predetermined template, which is suitable for the presentation of a table of links. In order to use this component, the programmer must provide a title for the table, as well as a table object including the links that should be included therein. The title and table object may be defined within the anchor table component, in which case the adaptation of the information is recursive, or by using the component ids of the title and table object to be included in the anchor table.

During adaptation, the adaptation server formats the provided title and table in accordance with the anchor table template. The anchor table may be generated using a scripting language such as JavaScript, which enables the presentation of an anchor table with a web-like look-and-feel to it. In devices that do not support JavaScript or other scripting languages, the adaptation server may define the anchor table using tags of an adaptation server specific markup language, or tags of a known markup language such as HTML, XHTML or WAP. In devices which generally provide a specific presentation method, such as the iPhone, the adaptation server adapts the anchor table in accordance with the device presentation conventions.

Additionally, the adaptation server may adapt the formatted information, structured in the layout defined by the template, to be suitable for display on the given device. For example, the adaptation server may adapt the table for display on devices which do not support tables. In this case the table may be displayed as an image by devices supporting the display of images, and may be displayed as a list in devices that do not support images or tables. Additionally, the adaptation server may change the dimensions of the table, if the screen of the device is not large enough to display the original dimensions. Furthermore, the adaptation server may adapt the links included in the table to the characteristics of the device, such as by making sure that they are in a style supported by the device, and that they do not exceed the width of the device screen.

The breadcrumbs component enables the generation of content based on a predetermined template, which is suitable for the presentation of a navigation object which displays objects for navigation within the adapted web site or web page.

During adaptation, the adaptation server generates a navigation object in accordance with a predefined template, and adds the navigation object to the web page being adapted. The navigation object may be generated using a scripting language such as JavaScript, which enables the presentation of a navigation object with a web-like look-and-feel to it. In devices that do not support JavaScript or other scripting languages, the adaptation server may define the navigation object using tags of an adaptation server specific markup language, or tags of a known markup language such as HTML, XHTML or WAP. In devices which generally provide a specific presentation method, such as the iPhone, the adaptation server adapts the navigation object in accordance with the device presentation conventions.

Additionally, the adaptation server may adapt the navigation object, structured in the layout defined by the template, to be suitable for display on the given device. For example, the adaptation server may adapt the navigation object for display on devices which do not toolbars. In this case the navigation object may be displayed as a list of links.

The form template component enables the generation of content based on a predetermined template, which is suitable for the presentation of a form. The template may be used for generating a login form, a search form, a drop down list form, and a radio button form. The parameters to be provided in order to use this component depend on the type of form being created. However, the programmer must define the type of form being created, and then may provide text object, text type input objects, images and/or submit type input objects as is suitable for the type of form being created. The provided objects may be defined within the form template component, in which case the adaptation of the information is recursive, or by using the component ids of the components to be included in the form template.

During adaptation, the adaptation server generates the required form based on the provided form components and in accordance with the template for the appropriate form type as defined by the programmer. The form may be generated using a scripting language such as JavaScript, which enables the presentation of a form with a web-like look-and-feel to it. In devices that do not support JavaScript or other scripting languages, the adaptation server may define the form using tags of an adaptation server specific markup language, or tags of a known markup language such as HTML, XHTML or WAP. In devices which generally provide a specific presentation method, such as the iPhone, the adaptation server adapts the form in accordance with the device presentation conventions.

The adaptation server further adapts the formatted information, structured in the layout defined by the template, to be suitable for display on the given device. For example, the adaptation server may change the dimensions of an image included in the generated form if the screen of the device is not large enough to display the original dimensions and/or if horizontal scrolling is not supported by the device. The adaptation server may also change the resolution of the image to be suited for the device. Additionally, since some devices only support some image formats, such as jpg, but do not support other image formats, such as tiff, the adaptation server may change the format of the image to be in a format supported by the requesting device. Furthermore, if the requesting device does not support the display of images, the adaptation server replaces the image with the text included in the ‘alt’ field of the image.

The adaptation server may also adapt the included text to the characteristics of the device, such as by making sure that it is in a style supported by the device, and that it does not exceed the width of the device screen.

The drop-down menu rule component is used to define a specific type of drop down menu for a specific device type or group of device types. In order to use this component, the programmer must provide a list of devices in which the specific drop down menu should be displayed, and a rule explaining how the drop down menu should be displayed in this device or group of devices. The rule is selected from a group of predefined rules, and, in use, overrides the device properties as defined in a devices database. The programmer can select a specific device to only use the rules that are applicable for the specific device.

During adaptation, the adaptation server generates a drop down menu constructed according to the instructions provided in the rule, regardless of the characteristics of the specific device. For example, the programmer may use a rule which instructs the adaptation server to adapt the drop down menu to be a JavaScript drop down menu, or to be a drop down menu opening from left to right or from right to left.

The horizontal menu rule component is used to define a specific type of horizontal menu for a specific device type or group of device types. In order to use this component, the programmer must provide a list of devices in which the specific horizontal menu should be displayed, and a rule explaining how the horizontal menu should be displayed in this device or group of devices. The rule is selected from a group of predefined rules, and, in use, overrides the device properties as defined in a devices database. The programmer can select a specific device to only use the rules that are applicable for the specific device.

During adaptation, the adaptation server generates a horizontal menu constructed according to the instructions provided in the rule, regardless of the characteristics of the specific device. For example, the programmer may use a rule which instructs the adaptation server to adapt the horizontal menu to be a JavaScript horizontal menu, or to be a degenerate, text based horizontal menu.

The vertical menu rule component is used to define a specific type of vertical menu for a specific device type or group of device types. In order to use this component, the programmer must provide a list of devices in which the specific vertical menu should be displayed, and a rule explaining how the vertical menu should be displayed in this device or group of devices. The rule is selected from a group of predefined rules, and, in use, overrides the device properties as defined in a devices database. The programmer can select a specific device to only use the rules that are applicable for the specific device.

During adaptation, the adaptation server generates a vertical menu constructed according to the instructions provided in the rule, regardless of the characteristics of the specific device. For example, the programmer may use a rule which instructs the adaptation server to adapt the vertical menu to be a JavaScript vertical menu, or to be a degenerate, text based vertical menu.

The button menu rule component is used to define a specific type of button menu for a specific device type or group of device types. In order to use this component, the programmer must provide a list of devices in which the specific button menu should be displayed, and a rule explaining how the button menu should be displayed in this device or group of devices. The rule is selected from a group of predefined rules, and, in use, overrides the device properties as defined in a devices database. The programmer can select a specific device to only use the rules that are applicable for the specific device.

During adaptation, the adaptation server generates a button menu constructed according to the instructions provided in the rule, regardless of the characteristics of the specific device. For example, the programmer may use a rule which instructs the adaptation server to adapt the button menu to be a JavaScript button menu, or to be a degenerate, text based menu instead of a button menu.

The tabbed menu rule component is used to define a specific type of tabbed menu for a specific device type or group of device types. In order to use this component, the programmer must provide a list of devices in which the specific tabbed menu should be displayed, and a rule explaining how the tabbed menu should be displayed in this device or group of devices. The rule is selected from a group of predefined rules, and, in use, overrides the device properties as defined in a devices, database. The programmer can select a specific device to only use the rules that are applicable for the specific device.

During adaptation, the adaptation server generates a tabbed menu constructed according to the instructions provided in the rule, regardless of the characteristics of the specific device. For example, the programmer may use a rule which instructs the adaptation server to adapt the tabbed menu to be a JavaScript tabbed menu, or to be a degenerate, text based menu instead of a tabbed menu.

The IG Filter component is used to wrap general markup language objects in tags of an adaptation server specific markup language. In order to use this component, the programmer must provide a list of components to be included within the generated tags. The components to be wrapped by the generated tags may be defined within the IG filter component, in which case the adaptation of the information is recursive, or by using the component ids of the links to be included in this component. As additional inputs of the IG Filter component, the programmer may define specific filters based on which the wrapped components should be displayed in the resulting adapted content. For example, the programmer may use an IG filter functionality which allows the definition of components to be displayed only in devices supporting specific markup languages. As another example, the programmer may use an IG filter functionality in order to display the same content in different formats, according to the requesting device. An illustration of this example can be displaying a list of links with icons next to them for devices with a wide screen, and use only the icons without the text for devices with narrow screens.

During adaptation, the adaptation server checks the characteristics of the device being used and determines whether the components included in the IG Filter component should be displayed in this device, based on the programmer definitions for the specific IG Filter component. If the components wrapped by the IG filter component should be displayed on the specific device being used, the adaptation server generates the appropriate markup language code for displaying these components. Each of the components displayed, is then adapted by the adaptation server as described hereinabove.

The create widget object component is used to generate a widget application which encapsulates selected components. In order to use this component, the programmer must provide a specific family of device for which the widgets is being defined, or an indication that the widget should be suitable for all devices and therefore all widget platforms may be used. The programmer must also selected data to be used by the encapsulating elements, or an indication that all data should be used, and an output location for the widget application. For example, the programmer may include in the web page which is suitable for adaptation a component which creates a widget that presents the user's favorites, a widget that contains an RSS subscription, a widget managing the user's preferences and a widget managing a web site's table of contents. Once downloaded, the widgets reside on the mobile communicator.

During adaptation, any data retrieved from any external source or network to be displayed on the device will be adapted to the device. For example, the list of favorite sites featured in the previous example will be optimally adapted for the use of the requesting device.

Reference is now made to Table 2, which provides listings of functions which may be used by an operator creating a web page which is suitable for adaptation.

For each function, Table 2 provides a brief description of the functionality of the function and of parameters which are required in order to use the function.

TABLE 2

| Function | | |
|---|---|---|
| name | Functionality | Required parameters |
| IgHeader | Creates an applicative header | 1. Content to be included in the header |
| | for the page, which header will | |
| | displayed at the top of each | |
| | deck, beneath the general | |
| | header generated by the system | |
| IgFooter | Creates an applicative footer | 1. Content to be included in the footer |
| | for the page, which header will | |
| | displayed at the bottom of each | |
| | deck, above the general header | |
| | generated by the system | |
| IgDeckNav | Generates a deck navigation | 1. Location for the deck navigation bar |
| | bar | to be inserted |
| | | 2. If desired, instructions for disabling |
| | | the default configuration of deck |
| | | navigation bars for a specific web page |
| IgPopUp | Creates an applicative popup | 1. Content to be included in the popup |
| | for a page, which is displayed | deck |
| | as an independent deck, prior | |
| | to the first deck of the page | |
| IgAlRow | Creates a row of access links | 1. List of access links to be included in |
| | | the row of access links |
| | | 2. If desired, instructions for how the |
| | | row of access links should be |
| | | formatted, regardless of the device type |
| | | on which it is being displayed |
| IgAlink | Creates an access link, which | 1. Access link ID - the id which will |
| | may be static or dynamic | be used to locate the access link |
| | | 2. Access Link Image - an image file |
| | | to be used as the icon for the link |
| | | 3. Access Link Tooltip - a description |
| | | to be shown when the mouse is |
| | | hovering over the access link, in |
| | | devices which support this |
| | | 4. Desired location of the access link - |
| | | in the header or footer |
| IgDeck | Generates a deck break | |
| IgPrefSize | Defines a preferred deck size | 1. Size - the preferred deck size in |
| | | bytes |
| IgAtom | Defines content which should | 1. Elements to be included in the single |
| | not be split into decks | atomic deck |
| IgPrefOutput | Defines the preferred markup | 1. Language - the preferred output |
| | language for the output of a | language |
| | page | |
| IgRefresh | Loads an additional web page | 1. URL of the page to be loaded |
| | after a defined time duration | 2. The time in seconds to be waited |
| | | prior to loading the new URL |
| IgPar | Instructs adaptation server to | |
| | insert an empty row into an | |
| | adapted web page | |
| IgTime | Instructs the adaptation server | 1. Time to begin displaying |
| | to display content within the | information within the tag |
| | tag during a specific period of | 2. Time to stop displaying information |
| | the day | within the tag |
| IgFolders | Instructs the adaptation server, | 1. BaseDir - the directory in which the |
| | when adapting for a specific | directories of all the images are located |
| | device type, to take a specific | 2. Device type list - list of device types |
| | component, such as an image, | to use images from different sub- |
| | from a specific folder, so that it | directories |
| | will be better suited to a | 3. Sub-directory list - list of sub- |
| | specific device and that | directories in which images for specific |
| | following adaptation the | devices are contained, corresponding |
| | quality of the component is not | to the list of device types |
| | compromised | |
| IgLeaveAsIs | Instructs the adaptation server | |
| | not to adapt content included in | |
| | the tag | |

Hereinbelow are additional details relating to each of the functions included in Table 2.

The function IgHeader defines an applicative header for a page, which header is displayed at the top of each deck, beneath the general header generated by the system. The function must include content to be included in the header. When processed by an adaptation server, such as server 104 of FIG. 1, the adaptation server adds the applicative header to the resulting adapted web page, and then proceeds to process all the content included in the applicative header in accordance with the processing definitions for each of the components, functions and attributes contained in the IgHeader tag.

For example, consider the following web page section:

<igheader>
text(“Welcome to My Web Page)
image(”my_picture.jpg”)
</igheader>

Following adaptation, this would create an applicative header including the text “Welcome to My Web Page” and the image from the file “my_picture.jpg”, which text and image would be processed by the adaptation server in accordance with the definitions for processing text and image components.

In a similar manner, the function IgFooter defines an applicative footer for a page, which footer is displayed at the bottom of each deck, above the general footer generated by the system. The function must include content to be included in the footer. When processed by an adaptation server, the adaptation server adds the applicative footer to the resulting adapted web page, and then proceeds to process all the content included in the applicative header in accordance with the processing definitions for each of the components, functions and attributes contained in the IgFooter tag.

The function IgDeckNav is used for generating a deck navigation bar, in cases in which the adaptation server breaks a webpage into decks, such as when the complete web page does not fit into the screen of the device and scrolling is not supported by the device. This function receives as parameters the desired location of the deck navigation bar, which may be selected from ‘top’, ‘bottom’ and ‘none’—where the ‘none’ option allows the user of this function to override default generation of a deck navigation bar and to instruct the adaptation server not to display a deck navigation bar, even if by default such a bar should be displayed.

When processing the IgDeckNav function, the adaptation server generates, for each deck, links to the previous and following decks, as well as links to the first and last decks. The generated deck navigation bar is then displayed in accordance with the capabilities of the specific device. For example, in a device supporting image links, the links to previous and following decks may be as a thumbnail image of the deck, or as an image of an arrow, and in a device which does not support image links the links may include the textual links ‘previous’ and ‘next’.

The function IgPopUp is used for generating an applicative popup page, which is displayed as an independent deck prior to display of the first deck of a page. The function must include content to be included in the popup deck. The function may additionally include a refresh attribute, which indicates how long, in seconds, the popup deck should be displayed prior to displaying the first deck of the page. When processed by an adaptation server, the adaptation server adds the popup deck to the web page prior to the first deck of the page, and then proceeds to process all the content included in the popup deck in accordance with the processing definitions for each of the components, functions and attributes contained in the IgPopUp tag.

For example, consider the following web page section:

<igpopup refresh=2>
text(“This is a popup message, it will go away in 2 seconds)
</igpopup>

Following adaptation, this would create a popup deck including the text “This is a popup message, it will go away in 2 seconds”, which popup deck will be displayed for two seconds, and then the first deck of the web page will be displayed. The text in the popup deck would be processed by the adaptation server in accordance with the definitions for processing text and image components.

The function IgAlink is used for generating an access link, which may be a static access link or a dynamic one. This function receives as parameters an access link id which is used to locate the access link, an access link image which is used as the icon for the link, a description to be shown to a user when the mouse is hovering over the access link, in devices which support this, and a desired location for the access link, which may be in the header or footer of the page.

When processing the IgAlink function, the adaptation server generates an access link displaying the image provided by the programmer, having the ID provided by the programmer and linking the location provided by the programmer. This may be achieved, for example, by defining the access link using tags of an adaptation server specific markup language, or tags of a known markup language such as HTML, XHTML or WAP. In devices that do not support the provision of text when the mouse hovers over a link, the adaptation server adds the explanatory text above the link in the adapted web page. Additionally, in devices which do not support the display of images, the image link is replaced by a textual link, such as one using the text provided by the programmer in the ‘alt’ attribute of the image.

The function IgAlRow is used for generating a row of access links, all of which are of the type IgAlink, which is described hereinabove. This function receives as parameters a list of access links to be included in the generated access link row. Additionally the programmer may provide instructions as to how the access link row should be formatted, regardless of the optimal formatting for a specific device. As an example, the programmer may set for a “nolimit” attribute of this function a Boolean value of 1, thereby instructing the adaptation server to ignore the width of the screen of the device when defining the length of the row of access links to be displayed.

When processing the IgAlRow function, the adaptation server generates a row of access links as defined in the parameters of the function. This may be achieved, for example, using a scripting language such as JavaScript, which enables the presentation of a row of access links with a web-like look-and-feel to it. In devices that do not support JavaScript or other scripting languages, the adaptation server may define the row of access links using tags of an adaptation server specific markup language, or tags of a known markup language such as HTML, XHTML or WAP. In devices which generally provide a specific presentation method, such as the iPhone, the adaptation server adapts the row of access links in accordance with the device presentation conventions. It is appreciated that each of the access links included in the row of access links is adapted in accordance with the adaptation sequence for IgAlink function, which is described hereinabove.

The function IgDeck is used for inserting a deck break. This function does not require any parameters, but may receive as an attribute the minimum size deck in bytes after which a new deck should be created. Alternatively the minimum deck size may be defined as a percentage of the maximum deck size that a device can handle.

The function IgPrefSize is used to define the preferred deck size, which preferred deck size, in bytes, is receives as a parameter of the function.

When processing the IgPrefSize function, the adaptation server creates decks of the preferred size, unless the IgDeck function is used, in which case a new deck is started in accordance with the definitions of the IgDeck function. Additionally, if the preferred deck size is too large for the device being used, the adaptation server creates decks in sizes that are suitable for display on the given device.

The function IgAtom is used for grouping a plurality of elements, functions or components as an atomic element, such that they will all be displayed in a single deck. This function receives as parameters a list of elements to be displayed in a single deck.

When processing the IgAtom function, if the current deck being processed does not have enough space to display all the elements in the IgAtom function, the adaptation server starts a new deck, even if the current deck is smaller than a minimum size defined by the IgDeck tag. If the content to be included in the atomic element is larger than the maximum deck size supported by a given device, the adaptation server splits the content into multiple decks and disregards the IgAtom function.

The function IgPrefOutput is used to define the preferred output markup language for the adapted page, an identification of which is provided as a parameter of the function.

When processing the IgPrefOutput function, the adaptation server determines whether the preferred output markup language is supported by the requesting device. If the preferred language is supported, the device receives the adapted page in this markup language. Otherwise, the adapted page is generated in the default markup language used by the device.

The function IgRefresh is used to load an additional page, or reload the same page, following the passage of a predetermined time duration. This function receives as parameters a URL of the page which is to be loaded onto the device, and the time duration in seconds which should be waited prior to loading this URL. The IgRefresh function is typically used for redirecting a user to another page, or for providing timed refreshing of the requested web page, in which case the URL provided as a parameter of the function is the same as the URL of the requested page.

When processing the IgRefresh function, the adaptation server determines whether the requesting device supports refreshing of pages. In some devices that do not support refreshing of pages, one can provide an equivalent to refreshing of pages by outputting both the original and refreshed page as WML pages. Therefore, it is recommended that the IgPrefOutput function be used to defined the preferred output language to be WML when using the IgRefresh function. If the device does not support refreshing of the page, and the refreshment of the web page cannot be simulated using WML due to the fact that the programmer did not define it to be the preferred output language, or if the device does not support WML, the adaptation server cannot refresh the page and only displays the original requested page.

The function IgPar is used to insert an empty line into the adapted web page. This is important because when adapting a web page or other content, the adaptation server avoids excess spacing by removing sequential <br> tags and replacing them with a single line break. Therefore, if a programmer wishes to add spacing to an adapted web page, the IgPar function must be used.

The function IgTime is used to wrap other elements of the content, such that the wrapped elements will only be displayed during certain hours of the day. As parameters, the IgTime function receives the time at which the wrapped elements should begin to be displayed, and the time at which they should stop being displayed, using a 24 hour clock.

When processing the IgTime function, the adaptation server determines the current time of day at the location of the user, and, if the time is within the range during which the information included within the IgTime function should be displayed, the adaptation server adapts each of the elements included in the IgTime tag in accordance with the descriptions provided hereinabove for each of the components and functions, and displays the adapted content. Otherwise, if the time is not in the defined range, the elements included in the IgTime tag are ignored.

The function IgFolders is used to instruct the adaptation server, when adapting for a specific device type or group of device types, to use an image or other file taken from a specific subdirectory of a main directory. Use of this function enables the reduction of processing time by the adaptation server, as it allows the programmer to define a component, such as an image, which would be better suited to a specific device, and ensures that the quality of a component is not compromised following adaptation. As parameters, the IgFolders function receives the pathway of the base directory, which includes all the versions of the component, and a list of pairs, each pair including a device type and the pathway to the subdirectory from which the suitable component for this device type should be taken.

When processing the IgFolders function, the adaptation server determines the type of device used, and accesses the appropriate directory using the paired list provided as a parameter to the IgFolders function in order to retrieve the appropriate version of the content to be included in the adapted web page. Once retrieved and included in the adapted web page, the suitable version of the content is adapted in accordance with the standard adaptation procedures for that component or function, as described hereinabove.

The function IgLeaveAsIs is used for ensuring that some elements, included in this function or in the tags defining this function, are not adapted by the adaptation server.

Reference is now made to Table 3, which provides listings of attributes which may be used by an operator creating a web page which is suitable for adaptation. The attributes are typically used in use of the components and functions described hereinabove with reference to Tables 1 and 2.

For each attribute, Table 3 provides a brief description of the functionality of the attribute, of parameters which are required in order to use the attribute, and a list of components and functions in which the attribute is typically used.

TABLE 3

| | | | Components, tags |
|---|---|---|---|
| | | | and functions in |
| Attribute | | Required | which attribute is |
| name | Functionality | parameters | used |
| IgTarget | Defines a device type | 1. Device type or | 1. Html ‘img’ tag |
| | or group of device | group of device | 2. Image component |
| | types in which an | types | 3. Any component or |
| | image should be | | function which |
| | displayed. In other | | includes an image as |
| | device types, the alt | | one of its parameters |
| | attribute is displayed | | |
| | instead of the image, if | | |
| | an alt attribute exists. | | |
| IgBest | Allows the | 1. Boolean value | 1. Html ‘img’ tag |
| | programmer to instruct | indicating if image | 2. Image component |
| | the adaptation server to | should be kept at | 3. Any component or |
| | ensure the quality of | maximum quality | function which |
| | an image to which the | or not | includes an image as |
| | attribute is applied | | one of its parameters |
| IgKeepSize | Allows the | 1. Boolean value | 1. Html ‘img’ tag |
| | programmer to instruct | indicating if image | 2. Image component |
| | the adaptation server to | should be kept at | 3. Any component or |
| | maintain the size of an | its original size or | function which |
| | image, particularly in | not | includes an image as |
| | devices which support | | one of its parameters |
| | horizontal scrolling | | |
| IgForce | Allows the | 1. Boolean value | 1. Html ‘img’ tag |
| | programmer to instruct | indicating if image | 2. Image component |
| | the adaptation server to | should be | 3. Any component or |
| | force an image to be | displayed even on | function which |
| | displayed even on | devices that are | includes an image as |
| | devices that are | normally set not to | one of its parameters |
| | otherwise set not to | display images | |
| | display images | | |
| IgNoMMS | Allows the | 1. Boolean value | 1. Html ‘img’ tag |
| | programmer to restrict | indicating if image | 2. Image component |
| | an image from being | may be sent in an | 3. Any component or |
| | sent as an MMS | MMS message | function which |
| | message | | includes an image as |
| | | | one of its parameters |
| IgTableFormat | Defines how a table | 1. Value indicating | 1. Html ‘table’ tag |
| | should be split in | how a table should | 2. Table component |
| | devices that don't | be split. May be | 3. Any component or |
| | support tables or if a | ‘Horizontal’, | function which |
| | table is too large for | ‘Vertical’, or | includes a table as one |
| | the screen of a device | ‘Asls’ | of its parameters |
| IgFormat | Defines the type and | 1. A string value | 1. Html ‘input’ tag |
| | number of characters | indicating the | 2. Form_Input |
| | which may be entered | number and type of | component |
| | in a text input field | characters which | 3. Any component or |
| | | may be used, and | function which |
| | | the sequence in | includes an input tag |
| | | which they may be | or a form input |
| | | used | component as one of |
| | | | its parameters |
| IgPfd | Instructs adaptation | 1. The attribute | 1. Html ‘input’ tag |
| | server to reduce the | name - IgPfd | 2. Form_Input |
| | amount of data sent to | 2. The attribute | component |
| | a target device when a | value - a hidden | 3. Any component or |
| | form includes static | field or parameter | function which |
| | hidden parameters | which should be | includes an input tag |
| | | stored in a local | or a form input |
| | | database of the | component as one of |
| | | adaptation server | its parameters |
| IgBypassIMP | Instructs the adaptation | 1. Boolean value | 1. Html ‘a’ tag (link) |
| | server to forward | indicating if | 2. Anchor component |
| | content to a requesting | content should be | 3. Any component or |
| | device without any | sent to requesting | function which |
| | adaptation, the link to | device as is | includes a link or an |
| | the page remains | | anchor component as |
| | unchanged | | one of its parameters |
| IgURLBypass | Instructs the adaptation | 1. The term | 1. any URL included |
| | server to forward | IgURLBypass | in the content |
| | content to a requesting | concatentated to | 2. Html ‘a’ tag (link) |
| | device without any | the value of the | 3. Anchor component |
| | adaptation, the | href attribute of the | 4. Any component or |
| | directive is | link | function which |
| | concatenated to the | | includes a URL, a link |
| | link to the page | | or an anchor |
| | | | component as one of |
| | | | its parameters |
| IgForceMarkup | Instructs the adaptation | 1. The term | 1. any URL included |
| | server to process the | IgForceMarkup | in the content |
| | content of a specific | concatenated to the | 2. Html ‘a’ tag (link) |
| | URL in a specific | end of a URL | 3. Anchor component |
| | markup language | 2. A value | 4. Any component or |
| | | indicating the | function which |
| | | markup language | includes a URL, a link |
| | | that should be used | or an anchor |
| | | | component as one of |
| | | | its parameters |
| IgImpersonate | Instructs adaptation | 1. The term | 1. any URL included |
| | server to alter user- | IgImpersonate | in the content |
| | agent information in | concatenated to the | 2. Html ‘a’ tag (link) |
| | requests of a specific | end of a URL | 3. Anchor component |
| | URL, such that the | 2. A value | 4. Any component or |
| | adaptation server | indicating the type | function which |
| | impersonates a device | of device which | includes a URL, a link |
| | when requesting the | should be | or an anchor |
| | web page | impersonated | component as one of |
| | | | its parameters |
| phoneTo | Generates a shortcut | 1. A telephone | 1. Html ‘a’ tag (link) |
| | for initiating a | number to be | 2. Anchor component |
| | telephone call | called | 3. Any component or |
| | | | function which |
| | | | includes a link or an |
| | | | anchor component as |
| | | | one of its parameters |
| AccessKey | Defines an access key | 1. The number or | 1. Html ‘a’ tag (link) |
| | for a link, thereby | character of the | 2. Anchor component |
| | allowing a user to | key that should be | 3. Any component or |
| | access the link by | used as the access | function which |
| | pressing one key on | key | includes a link or an |
| | his mobile device | | anchor component as |
| | | | one of its parameters |

Hereinbelow are additional details relating to each of the attributes included in Table 3.

The attribute IgTarget is an attribute suitable for use with image components and tags, which, when processed by the adaptation server, defines a device type or group of device types in which the image should be displayed. The groups of devices may be defined based on device categories, or based on a specific common capability, such as the ability to display a specific markup language. In all other devices, the alt attribute of the image is displayed instead of the image. However, in devices where the image is displayed, it may be adapted by the adaptation server to be optimal for display on that device, as described hereinabove with reference to the image component. It is appreciated that the IgTarget attribute may be used in an image component, an ‘img’ HTML tag, or any other component or function which includes an image as one of its inputs or parameters.

The attribute IgBest is a Boolean attribute suitable for use with image components and tags, which allows the programmer to instruct the adaptation server not to reduce the quality of a given image, even if, for example, it would require creating a new deck sooner than otherwise defined or required. When processed by the adaptation server; if the value of the IgBest attribute is set to 1, the image is displayed as is, without being adapted for a specific device. Otherwise, the image is adapted as described hereinabove with reference to the image component. It is appreciated that the IgBest attribute may be used in an image component, an ‘img’ HTML tag, or any other component or function which includes an image as one of its inputs or parameters.

The attribute IgKeepSize is a Boolean attribute suitable for use with image components and tags, which allows the programmer to instruct the adaptation server not to change the size of a given image, particularly in devices which support horizontal scrolling. When processed by the adaptation server, if the value of the IgKeepSize attribute is set to 1, the image is not resized prior to display, even if its dimensions exceed those of the device screen. Otherwise, the image is adapted as described hereinabove with reference to the image component. It is appreciated that the IgBest attribute may be used in an image component, an ‘img’ HTML tag, or any other component or function which includes an image as one of its inputs or parameters.

The attribute IgForce is a Boolean attribute suitable for use with image components and tags, which allows the programmer to instruct the adaptation server to display a given image even on devices which are normally set not to display images. It is appreciated that the IgForce attribute may be used in an image component, an ‘img’ HTML tag, or any other component or function which includes an image as one of its inputs or parameters. In the event a device completely lacks the ability to display images, the image marked with this tag will be ignored.

The attribute IgNoMMS is a Boolean attribute suitable for use with image components and tags, which allows the programmer to instruct the adaptation server to restrict sending of a given image as an MMS message. This attribute may be used, for example, when an image is an anchor. It is appreciated that the IgNoMMS attribute may be used in an image component, an ‘img’ HTML tag, or any other component or function which includes an image as one of its inputs or parameters.

The attribute IgTableFormat is an attribute suitable for use with table components and tags, which allows the programmer to define how a table should be split in devices that do not support tables, or if the dimensions of the table are too large to fit in the screen of a given device. The attribute value may be selected from ‘horizontal’, indicating that the table should be split horizontally, resulting in multiple rows, ‘vertical’, indicating that the table should be split vertically, resulting in multiple columns, and ‘AsIs’ indicating that the original structure should be maintained wherever possible.

When processed by the adaptation server, if the device is capable of displaying the entire table, nothing is done. Otherwise, the table is divided in accordance with the value of the attribute. However; if the value of the attribute is ‘AsIs’, and the device cannot display the table as is, the table is divided horizontally. It is appreciated that the IgTableFormat attribute may be used in a table component, a ‘table’ HTML tag, or any other component or function which includes a table as one of its inputs or parameters.

The attribute IgFormat is an attribute suitable for use with a text type input field, which allows the programmer to define the type and number of characters which may be entered in a text input field. The attribute value is typically a string of characters having a fixed length. The length of the character string defines the maximum length of a permissible input into the field, and each character in the string represents a group of characters which may be used in that location in the text being input. It is appreciated that the IgFormat attribute may be used in a form input component, an ‘input’ HTML tag, or any other component or function which includes a form input as one of its inputs or parameters.

The attribute IgPfd is an attribute suitable for use with a hidden type input field, which allows the programmer to reduce the amount of data and hidden field information which is sent to the target device. The data which is not sent to the target device is preferably stored in a local database of the adaptation server. It is appreciated that the IgPfd attribute may be used in a form input component, an ‘input’ HTML tag, or any other component or function which includes a form input as one of its inputs or parameters.

The attribute IgBypassIMP is a Boolean attribute suitable for use with anchor components and tags, which allows the programmer to instruct the adaptation server not to adapt the page to which the anchor is directed. It is appreciated that the IgBypassIMP attribute may be used in an anchor component, an ‘a’ HTML tag, or any other component or function which includes a link as one of its inputs or parameters.

The attribute IgURLBypass is an attribute which is appended to the URL included in the href attribute of a link, thereby instructing the adaptation server not to adapt the page to which the link is directed. It is appreciated that the IgURLBypass attribute may be used in an anchor component, an ‘a’ HTML tag, or any other component or function which includes a link as one of its inputs or parameters.

The attribute IgForceMarkup is an attribute which is appended to the URL included in the href attribute of a link, thereby instructing the adaptation server, when the link is clicked, to provide an adapted version of that page in the specified markup language. Preferably, the term IgForceMarkup is appended to the URL together with an indication of the markup language to be used, as in the following example:

<a href=“www.cnn.com?IgForceMarkup=WML/>

It is appreciated that the IgForceMarkup attribute may be used in an anchor component, an ‘a’ HTML tag, or any other component or function which includes a link as one of its inputs or parameters.

The attribute IgImpersonate is an attribute which is appended to the URL included in the href attribute of a link, thereby instructing the adaptation server, when the link is clicked, to alter user-agent information in requests of a specific URL, such that the adaptation server impersonates a device when requesting the web page located at the specific URL. Preferably, the term IgImpersonate is appended to the URL together with an indication of the markup language to be used, as in the following example:

<a href=“www.cnn.com?IgImpersonate=iPhone/>

It is appreciated that the IgImpersonate attribute may be used in an anchor component, an ‘a’ HTML tag, or any other component or function which includes a link as one of its inputs or parameters.

The attribute phoneto is an attribute suitable for use in an anchor component or tag, which generates a shortcut for initiating a telephone call. As a value of this attribute, the programmer must provide the telephone number to be called. It is appreciated that the phoneto attribute may be used in an anchor component, an ‘a’ HTML tag, or any other component or function which includes a link as one of its inputs or parameters.

The attribute AccessKey is an attribute suitable for use in an anchor component or tag, which defines an access key for a link, thereby allowing the user to access the link by pressing a button on his mobile communicator keypad. As a value of this attribute, the programmer must provide the number or character of the key to be used as an access key. Typically, only numerical keys and the # symbol are used as access keys. It is appreciated that the phoneto attribute may be used in an anchor component, an ‘a’ HTML tag, or any other component or function which includes a link as one of its inputs or parameters.

Reference is now made to FIGS. 4A and 4B, which, when taken together, form a simplified flowchart illustrating adaptation of an application, which occurs at a mobile device adaptation server, such as server 104 in FIG. 1, in accordance with an embodiment of the present invention.

As seen at step 400 of FIG. 4A, the mobile device adaptation server receives a request for an application, such as a web page, from a user, which request includes information identifying the type of device from which the request is transmitted, and information identifying communities to which the user of the device belongs, such as a service provider for the device.

The server then retrieves from the request the information identifying the type of device being used and the information identifying the communities to which the user belongs, as seen at step 402. The server then accesses a device type database associated therewith, and retrieves information regarding the characteristics and capabilities of the specific device type, as seen at step 403.

Subsequently or in parallel, the server downloads the requested application from one or more sources thereof, such as application server 102 in FIG. 1, as seen at step 404, and parses the content into components and functions, as seen at step 406.

As seen at step 408, for each component and function identified in the downloaded application, the server confirms that the component or function are valid, which may include checking that the component or function name is one that the server recognizes, and that all required parameters for the component or function have been provided.

If a component or function is not valid, it is ignored, as seen at step 410.

For valid components and functions, the server proceeds to determine the sequence of server internal operations or functions which should be applied in order to adapt the component or function, as seen at step 412. As seen at step 414, the server then checks if the application programmer has indicated that certain characteristics of devices should be overridden. The operator may provide such information as part of the attributes or parameters provided with the component or function. For example, the operator may override an image display characteristic of the device, and instruct the server to display text as a replacement for the image even if the device can support display of the image.

If override instructions were provided by the programmer, the server creates an internal indication that certain characteristics of the device should be overridden for this function or component, and temporarily defines suitable characteristics for the device in accordance with the instructions provided by the programmer, as seen at step 416.

As seen at step 418, the server then applies the attributes and characteristics of the device, as retrieved from the database or as defined in step 416, to the component or function which is being processed, in order to establish the optimal way of presenting the component or carrying out the function on the given device having the specific attributes and characteristics.

Once the optimal presentation is established, the server formats the application accordingly, and adds the formatted application to an adapted web page which will be displayed to the user following adaptation of all the components included therein, as seen at step 420.

Turning to FIG. 4B, as seen at step 422, following adaptation of each of the components and functions in the downloaded application, the server may optionally access the information identifying a community to which the user of the specific device belongs, such as a service provider, and may determine if such a community exists, as seen at step 423.

If such a community exists, the server may optionally access the database associated therewith to retrieve information regarding requirements for pages adapted for devices used by users belonging to a given community, as seen at step 424. The server then may optionally determine whether the adapted web page should be modified to be suitable for the given community, as seen at step 425. If the adapted web page needs to be modified, the server may optionally carry out the modification to generate the adapted web page which should be displayed to the user, as seen at step 426.

Finally, the server paginates the application to create decks having the appropriate size or characteristics as defined by the programmer, as seen at step 428, and adds navigational links within each of the resulting decks to enable a user to move from one deck to another, as seen at step 430. The adapted web page is then ready for display on the specific device from which the request was initially received.

It will be appreciated by persons skilled in the art that the present invention is not limited to what has been particularly shown and described hereinabove. Rather the scope of the present invention includes both combinations and subcombinations of various features described hereinabove as well as modifications of such features which would occur to a person of ordinary skill in the art upon reading the foregoing description and which are not in the prior art.

1. A method for creating applications optimized for use on multiple mobile devices, the method comprising:
using a computer to generate a single version of an application including at least one of content and functionality;
providing said single version of said application via a computer network to a mobile device adaptation server; and
employing said mobile device adaptation server to automatically modify said single version of said application so as to create multiple versions corresponding to said single version, each of said multiple versions being optimized for at least one different mobile device platform.

2-4. (canceled)

5. A method for creating applications optimized for use on multiple mobile devices according to claim 1 and wherein said single version is suitable for presentation on a mobile device.

6. (canceled)

7. A method for creating applications optimized for use on multiple mobile devices according to claim 1 and wherein said single version is not suitable for presentation on a mobile device.

8. A method for creating applications optimized for use on multiple mobile devices according to claim 1 and wherein said employing said mobile device adaptation server comprises:
automatically creating said multiple versions each having user interface features matched to the user interfaces of at least one different mobile device platform.

9. A method for creating applications optimized for use on multiple mobile devices according to claim 1 and wherein said employing said mobile device adaptation server comprises:
automatically creating said multiple versions each having functional features matched to the functional capabilities of at least one different mobile device platform.

10. A method for creating applications optimized for use on multiple mobile devices according to claim 1 and wherein said employing said mobile device adaptation server to automatically modify said single version to create multiple versions takes place in real time in response to a request.

11. A method for creating applications optimized for use on multiple mobile devices according to claim 1 and wherein said using a computer to generate a single version comprises defining one or more sources.

12. A method for creating applications optimized for use on multiple mobile devices according to claim 11 and wherein said using a computer to generate a single version also comprises manipulating said one or more sources.

13. A method for creating applications optimized for use on multiple mobile devices according to claim 11 and wherein said one or more sources comprise at least one of a web page, an XML file, an RSS feed, a file type and an API type.

14. A method for creating applications optimized for use on multiple mobile devices according to claim 11 and wherein said using a computer to generate a single version also comprises defining structures and rules for retrieving data from said one or more sources and for manipulation of said data retrieved.

15. A method for creating applications optimized for use on multiple mobile devices according to claim 11 and wherein said using a computer to generate a single version also comprises defining a style, a layout and a look-and-feel for said application.

16. A method for creating applications optimized for use on multiple mobile devices according to claim 11 and wherein said using a computer to generate a single version also comprises defining a desired user interface and functionality.

17. A method for creating applications optimized for use on multiple mobile devices according to claim 11 and wherein said using a computer to generate a single version also comprises using a plurality of components, functions and attributes to define attributes of a mobile communicator page.

18. A method for creating applications optimized for use on multiple mobile devices according to claim 17 and wherein said attributes of a mobile communicator page are defined using an application specific markup language.

19. A method for creating applications optimized for use on multiple mobile devices according to claim 11 and also comprising previewing said single version.

20. A method for creating applications optimized for use on multiple mobile devices according to claim 11 and also comprising previewing at least one of said multiple versions.

21. A system for creating applications optimized for use on multiple mobile devices, the system comprising:
a computer operative to generate a single version of an application including at least one of content and functionality; and
a mobile device adaptation server, connected to said computer via a computer network, operative to automatically modify said single version of said application so as to create multiple versions corresponding to said single version, each of said multiple versions being optimized for use on at least one different mobile device platform.

22-24. (canceled)

25. A system for creating applications optimized for use on multiple mobile devices according to claim 21 and wherein said single version is suitable for presentation on a mobile device.

26. (canceled)

27. A system for creating applications optimized for use on multiple mobile devices according to claim 21 and wherein said single version is not suitable for presentation on a mobile device.

28. A system for creating applications optimized for use on multiple mobile devices according to claim 21 and wherein said multiple versions each have user interface features matched to the user interfaces of at least one different mobile device platform.

29. A system for creating applications optimized for use on multiple mobile devices according to claim 21 and wherein said multiple versions each have functional features matched to the functional capabilities of at least one different mobile device platform.

30. A system for creating applications optimized for use on multiple mobile devices according to claim 21 and wherein said mobile device adaptation server is operative to create one of said multiple versions by automatically modifying said single version in real time in response to a request, said one of said multiple versions being optimized for a mobile device sending said request.

31. A system for creating applications optimized for use on multiple mobile devices according to claim 21 and wherein said single version includes one or more sources.

32. A system for creating applications optimized for use on multiple mobile devices according to claim 31 and wherein said computer is operative to generate said single version by manipulating said one or more sources.

33. A system for creating applications optimized for use on multiple mobile devices according to claim 31 and wherein said one or more sources comprise at least one of a web page, an XML file, an RSS feed, a file type and an API type.

34. A system for creating applications optimized for use on multiple mobile devices according to claim 31 and wherein said computer is operative to define structures and rules for retrieving data from said one or more sources and for manipulation of said data retrieved.

35. A system for creating applications optimized for use on multiple mobile devices according to claim 31 and wherein said computer is operative to define a style, a layout and a look-and-feel for said application.

36. A system for creating applications optimized for use on multiple mobile devices according to claim 31 and wherein said computer is operative to define a desired user interface and functionality.

37. A system for creating applications optimized for use on multiple mobile devices according to claim 31 and wherein said computer is operative to use a plurality of components, functions and attributes to define attributes of a mobile communicator page.

38. A system for creating applications optimized for use on multiple mobile devices according to claim 37 and wherein said attributes of a mobile communicator page are defined using an application specific markup language.

39. A system for creating applications optimized for use on multiple mobile devices according to claim 31 and also comprising a viewer operative to preview said single version.

40. A system for creating applications optimized for use on multiple mobile devices according to claim 39 and wherein said viewer is operative to preview at least one of said multiple versions.

41. A system for creating applications optimized for use on multiple mobile devices according to claim 22 and wherein said request includes information identifying the type of mobile communicator requesting said application.

42. A system for creating applications optimized for use on multiple mobile devices according to claim 21 and also comprising a mobile communicator characteristics database operative to store characteristics of said mobile device.

43. A system for creating applications optimized for use on multiple mobile devices according to claim 22 and wherein said request includes information identifying a community to which a user of the mobile communicator making said request belongs.

44. A system for creating applications optimized for use on multiple mobile devices according to claim 22 and also comprising a community requirements database operative to store characteristics of said at least one different community of users.
